(19) United States
(12) Patent Application Publication
(10) Pub. No.: US 2020/0310541 A1
(43) Pub. Date: Oct. 1, 2020

(54) SYSTEMS AND METHODS FOR CONTROL SCHEMES BASED ON NEUROMUSCULAR DATA

(71) Applicant: Facebook Technologies, LLC, Menlo Park, CA (US)

(72) Inventors: Jason Reisman, New York, NY (US); Ran Rubin, New York, NY (US); Vinay Jayaram, New York, NY (US); Tanay Singhal, Tarrytown, NY (US); Daniel Wetmore, Brooklyn, NY (US)

(21) Appl. No.: 16/833,626

(22) Filed: Mar. 29, 2020

Related U.S. Application Data
(60) Provisional application No. 62/826,493, filed on Mar. 29, 2019.
(60) Provisional application No. 62/840,803, filed on Apr. 30, 2019.
(60) Provisional application No. 62/968,495, filed on Jan. 31, 2020.

(51) Int. Cl. G06F 3/01; G06F 3/0488; G06K 9/62

(52) U.S. Cl. CPC G06F 3/015; G06K 9/6251; G06K 9/6263; G06F 3/04883

(57) ABSTRACT

The disclosed systems and methods are generally directed generating user control schemes based on neuromuscular data. The disclosed systems and methods may comprise feature space or latent space representations of neuromuscular data to train users and for users to achieve greater neuromuscular control of machines and computers. In certain embodiments, the systems and methods employ multiple distinct inferential models (e.g., full control schemes using inferential models trained in multiple regions of a feature space). Various other methods, systems, and computer-readable media are also disclosed.

### CROSS REFERENCE TO RELATED APPLICATION

This application claims the benefit of U.S. Provisional Application No. 62/826,493, filed 29 Mar. 2019; U.S. Provisional Application No. 62/840,803 filed 30 Apr. 2019; and U.S. Provisional Application No. 62/968,495 filed 31 Jan. 2020, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an example feature space for neuromuscular data.

FIG. 2 is an illustration of the example feature space of FIG. 1 and a transition within the feature space.

FIG. 3 is an illustration of an example graphical user interface for online training of an inference model for 2D movement via wrist rotation.

FIG. 4 is an illustration of a plot comparing distributions of data points for training different inference models.

FIG. 5 is an illustration of the example feature space of FIG. 1 and another transition within the feature space.

FIG. 6 is an illustration of example plots of processed neuromuscular data that represent 2D visualizations of latent vectors representing user hand poses.

FIG. 7 is an additional illustration of example plots of processed neuromuscular data that represent 2D visualizations of latent vectors representing user hand poses.

FIG. 8 is an additional illustration of example plots of processed neuromuscular data that represent 2D visualizations of latent vectors representing user hand poses.

FIG. 9 is an additional illustration of example plots of processed neuromuscular data that represent 2D visualizations of latent vectors representing user hand poses.

FIG. 10 is an illustration of an example interface for visualizing processed neuromuscular data with 2D visualizations of latent vectors representing user hand poses.

FIG. 11 is an illustration of an example training task for an inferential model.

FIGS. 12A-C are illustrations of an example interface for cursor control based on the application of inferential models to neuromuscular data.

FIGS. 13A-B are illustrations of representations of path efficiency metrics.

FIGS. 14A-B are illustrations of representations of stability metrics.

FIGS. 15A-B are illustrations of representations of reachability metrics.

FIG. 16 is an illustration of a representation of combinatorics metrics.

FIG. 17 is an illustration of example cursor indicators.

FIGS. 18A-B are illustrations of example plots of continuous 1D output of the neuromuscular data produced by sensing a pair of muscles.

FIG. 19 is an illustration of a 1D neuromuscular signal mapped to a feature space.

FIG. 20 is an illustration of example event paths through the feature space illustrated in FIG. 19.

FIG. 21 is an illustration of the event paths of FIG. 20 in the context of a Mahalanobis distance metric.

FIG. 22 is an illustration of the event paths of FIG. 20 in the context of a negative-log-likelihood based distance metric.

FIG. 23 is an illustration of the event paths of FIG. 20 in the context of a support vector machine score distance metric.

FIG. 24 is an illustration of an example plot of a 2D feature space.

FIG. 25 is an illustration of a plot of neuromuscular data over time as a user performs various gestures.

FIG. 26 is an illustration of a zoomed-in portion of the plot of FIG. 25.

FIG. 27 is an illustration of a plot of an example function used in a modified one Euro filter.

FIGS. 28A-B are illustrations of example plots of model predictions using a one Euro filter and a modified one Euro filter, respectively.

FIG. 29 is an illustration of an example system for inferring gestures based on neuromuscular data.

FIG. 30 is an illustration of an example wearable device for sensing neuromuscular data.

FIGS. 31A-B are schematic illustrations of an example wearable system for sensing neuromuscular data.

FIG. 32 is an illustration of exemplary augmented-reality glasses that may be used in connection with embodiments of this disclosure.

FIG. 33 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to systems and methods for generating user control schemes based on neuromuscular data. The disclosed systems and methods may comprise feature space or latent space representations of neuromuscular data to train users and for users to achieve greater neuromuscular control of machines and computers. In certain embodiments, the systems and methods employ multiple distinct inferential models (e.g., full control schemes using inferential models trained in multiple regions of a feature space). A control scheme as discussed herein may be regarded as a set of input commands and/or input modes that are used alone or in combination to reliably control computers and/or electronic devices. For example, neuromuscular data (e.g., gathered from wearable devices with neuromuscular sensors) may be provided as input to a trained inferential model which identifies an intended input command on the part of the user. In certain scenarios, independently trained models may lack both contextual information and invariances needed to be part of a full control scheme for a control application. The systems and methods described herein may allow for the selective utilization of one or more trained models based on the circumstances surrounding the data inputs (e.g., directing the system to use one model to interpret data within a feature space and another model to interpret data that lies within a different region of the feature space). In one example embodiment, systems and methods described herein may allow a user using an armband or wristband with neuromuscular sensors to have finer control of a virtual pointer on a 2D map and may also allow for better control of a user's interactions with the 2D map and its various functional features.

Generally speaking, machine learning models may perform better when provided input from a specific subset/subregion of a feature space, rather than from arbitrary locations in the feature space. When input is from the relevant region in the feature space, model output may tend to be more reasonable. However, when data inputs fall outside of that region, model performance may suffer. The term “feature space” can comprise one or more vectors or data points that represent one or more parameters or metrics associated with neuromuscular signals such as electromyography (“EMG”) signals. As an example, an EMG signal possesses certain temporal, spatial, and temporospatial characteristics, as well as other characteristics such as frequency, duration, and amplitude, for example. A feature space can generated based on one or more of such characteristics or parameters.

The disclosed systems and methods allow for full control schemes by better identifying when data inputs fall within one or more regions or point clouds of a feature space and applying the appropriately trained model(s) for specific data points that lie within the various regions of the feature space. In certain embodiments, the systems and methods disclosed herein can select from different types of control schemes or input modes and can apply the applicable trained machine learning model(s) to the inputs based on the type of schemes and/or modes selected. The selection of different schemes and/or input modes can be done manually by a user or automatically by the system. For example, the disclosed systems and methods may allow the user to maintain effective control over a connected machine if the user switches between different types of control schemes or input modes. Such schemes and modes include but are not limited to surface typing, typing on the user's leg, using a first and wrist to control a virtual pointer in 2D, drawing, writing, or any other specific or general activity that a user can perform. In one example embodiment, a user could be typing on a surface, and the disclosed systems and methods are able to detect that activity and apply a trained inferential model or machine learning model that was trained based on a set of training data inputs obtained from one or more users while typing various words and phrases while keeping their hands on a surface. If the systems and methods detect that the user is now typing on their leg, a different model can be used to infer typing outputs with that model having been trained on data inputs from one or more users who typed various words and phrase on their legs. In this way, the systems and methods herein can apply the more appropriately trained model to produce more accurate outputs depending on the specific user activity.

In another embodiment, the user can be performing hand gestures and want to switch to a drawing mode. Because the inferential models trained to classify hand gestures accurately can differ from the inferential models trained to identify a user's drawing actions, it would be advantageous for the systems and methods to apply the appropriately trained inferential models to the activity upon which training data was used to generate the models. In another embodiment, a user could be performing discrete hand gestures such as snapping, pinching, etc. and can switch to performing continuous hand gestures such as making a first with varying levels of force, holding a pinch with various levels of force, etc. In another example, a user could be performing a series of index finger to thumb pinches and then want to switch to a series of middle finger to thumb pinches. In any of these examples, the disclosed systems and methods can implement a more appropriately trained inferential model to predict the user's intended action(s) in one input mode and use another more appropriately trained model to predict the user's intended action(s) in another input mode. The systems and methods disclosed herein can automatically detect a user's transition from one input mode or control scheme to another based on any one or more of the following: processed neuromuscular input data, spatio-temporal data from an IMU device (e.g., comprising an accelerometer, gyroscope, magnetometer, etc.), infrared data, camera and/or video based imaging data. The user can also instruct the systems and methods to switch between modes or control schemes based on neuromuscular input data (e.g., specific handstates, gestures, or poses) and/or verbal commands.

In certain embodiments, a neuromuscular armband or wristband can be implemented in the disclosed systems and methods. In other embodiments, the user can be utilizing the wrist band in combination with grasping a virtual or physical object including but not limited to a real or virtual remote control, gaming device, steering wheel, mobile phone, ball, pen/stylus, etc.

Using the systems and methods disclosed herein, a 2D linear model may perform well when the data inputs are from the subregion of a feature space where the model was trained. In some examples, such subregions may be identified within a feature space using a feature extraction and/or clustering technique. For example, a cluster of data points within a feature space may define a subregion, where the size of the subregion is estimated as the covariance of the data points and the distance from the center of the subregion is determined by the Mahalanobis distance of a point from the cluster of data points. Thus, if the Mahalanobis distance (or analogous metric) of an input places the input within the subregion, systems and methods described herein may apply an inferential model corresponding to the subregion to interpret the input. Conversely, if the Mahalanobis distance (or analogous metric) of an input places the input outside the subregion but within an alternate subregion, systems and methods described herein may apply an alternate inferential model corresponding to the alternate subregion to interpret the input.

In some examples, an input may not fall within any previously defined subregion of a feature space, for which there is an associated inferential model. In these examples, the systems and methods may handle the input in any of a variety of ways. For example, the systems and methods may identify a new default inferential model and apply the new default inferential model to interpret the input. In another example, the systems and methods may determine the nearest defined subregion (e.g., where “nearest” is determined according to Mahalanobis distance or an analogous metric) and apply the inferential model corresponding to the nearest subregion in the feature space to interpret the input. Additionally or alternatively, the systems and methods described herein may notify the user that the user's input is subject to misinterpretation and/or prompt the user to modify future input to comport more closely with a defined subregion of the feature space (e.g., by entering a training interface that provides feedback to the user regarding whether and/or how closely the user's input aligns with a currently selected input mode and/or with any input mode). In some examples, the systems and methods described herein may generate a new inferential model based on receiving inputs outside any defined subregion. For example, these systems and methods may prompt a user to perform actions intended by the user to represent specific inputs and then train a new model (or modify a copy of an existing model) to correspond to a new subregion defined by the user's prompted actions.

By applying appropriately trained models to differing neuromuscular data, the systems and methods described herein may improve the functioning of human-computer interface systems, representing an improvement in the function of a computer that interprets neuromuscular data as well as an advancement in the fields of interface devices, augmented reality, and virtual reality.

Features from any of the embodiments described herein may be used in combination with one another in accordance with the general principles described herein. These and other embodiments, features, and advantages will be more fully understood upon reading the following detailed description in conjunction with the accompanying drawings and claims.

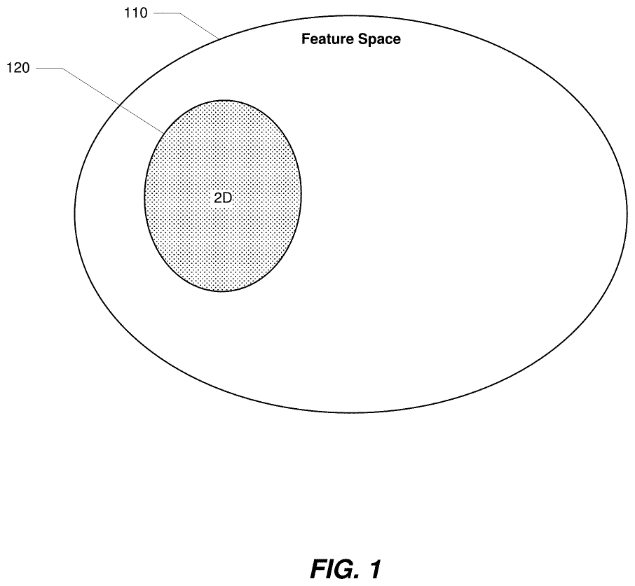

By way of illustration, FIG. 1 shows an example feature space 110. In one example, feature space 110 may represent a mapping of a user's movements, including, e.g., wrist motion. As shown in FIG. 1, most of the user's wrist motion may ordinarily stay within subregion 120 of feature space 110. In the case where the user's wrist motions are used as inputs for manipulating a 2D laser pointer, inputs that fall within subregion 120 of feature space 110 may allow for reliable control of the 2D laser pointer within the system.

When mapped data inputs fall outside of subregion 120 of feature space 110 (e.g., if the user squeezes their first during wrist rotation as opposed to using an open-hand—or even uses a more tightly held first rather than a more loosely held one) the performance of the 2D model for inferring wrist rotation outputs may deteriorate. With varying degrees of force that can accompany the making of a fist, the user may not perceive a slight change in the amount of force applied in making a first as being significant. However, an inferential model trained on certain parameters may vary in performance under certain situations and circumstances. In a feature space defined for certain events (e.g., a tightly held first versus a loosely held fist), the difference in mapped data points or vectors can be significant and thus affect system performance. In the example shown in FIG. 1, when a user squeezes their fist, a cursor being controlled by the user through neuromuscular inputs to the system (e.g., with wrist rotation) may suddenly jump and no longer be positioned where the user intends it to be. This is can be referred to as an “event artifact,” which can be attributed to the changes in force associated with a user's first being squeezed during wrist rotation versus it being in a relaxed state during wrist rotation. The user's squeezing of their first can cause a transition of data inputs from the EMG sensors to a different subregion of 2D space in the feature space, one outside of subregion 120 where the 2D model has not been trained. Once outside subregion 120 of feature space 110, there may be still be some degree of control possible, but the model's output may be regarded as essentially undefined. Accordingly, any shifting in subregions of a feature space during user activity may be attributed to the user changing input modes or control schemes or may be attributed to the user staying within the same input mode or control scheme but changing a parameter in that input mode or control scheme.

The systems and methods disclosed herein may eliminate, mitigate, and/or otherwise address event artifacts by using a plurality of trained models under certain data collection scenarios. Various embodiments of the present disclosure may detect when the transitions between subregions in a feature space are occurring or have occurred. Transitions between subregions in a feature space may be detected in any of a variety of ways, thereby allowing the systems and methods described herein to determine whether the incoming data set is or is not well-suited for a particular trained inferential model. For example, the systems and methods described herein may detect transitions from one subregion to another calculating the Mahalanobis distance from a user input (or of a cluster of user inputs over a recent time period) to one or more subregions (e.g., the subregion corresponding to the most recently selected control mode along with other subregions representing other control modes). In various other examples, the systems and methods described herein may detect transitions from one subregion to another by using a binary classifier, a multinomial classifier, a regressor (to estimate distance between user inputs and subregions), and/or support vector machines.

Once a change in a subregion of a feature space occurs, the systems and methods described herein may employ a better-trained, and thus better-suited, inferential model to analyze the neuromuscular inputs and infer more accurate outputs. In this way, by employing the best-suited trained model for any given user activity, the system may implement full control schemes by recognizing poor performance using a specific model and calling on other more suited models as a function of where the mapped input data sets are landing in a feature space. Although the present disclosure describes improving control schemes by selecting one of multiple models for use, some implementations of model selection may be understood as an overarching model that contains and/or implements each of the multiple models. For example, an overarching model may functionally use the subregion within which an input falls as a key feature in determining how other characteristics of the input will be interpreted. In some examples, multiple models may be blended together by computing blending or mixing coefficients that indicate a level of trust or weight to give to each candidate model for a given input.

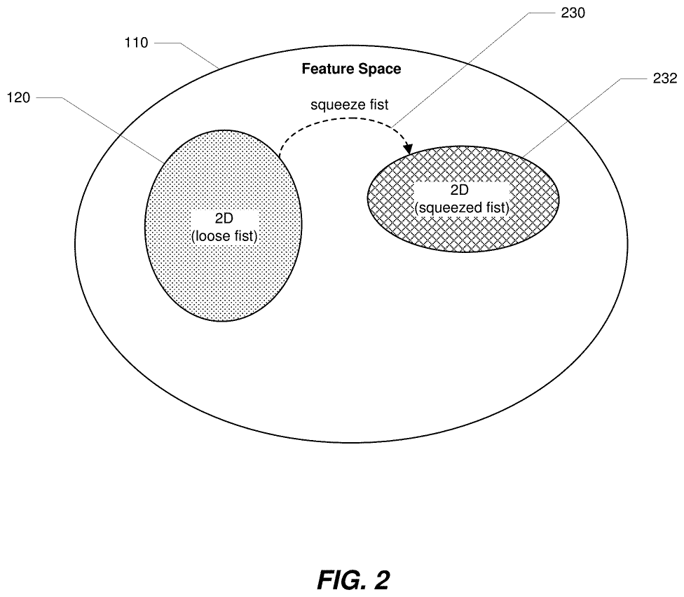

As described above by way of example in connection with FIG. 1, a user could be performing the previously described wrist 2D movement with their first squeezed. By way of illustration, FIG. 2 shows the feature space 110 of FIG. 1 with a transition 230 from subregion 120 (where the user is moving their wrist while their first is loose) to a subregion 232 (where inputs are observed when the user is moving their wrist while their first is squeezed). A first squeeze could be used for a discrete/instantaneous event (e.g., to engage or disengage a particular feature within a given application), as well for a continuous/hold event (e.g., to maintain activation of a particular feature within a given application). In the case of a continuously held event, inputs (e.g., involving 2D movements of the wrist) that may otherwise normally fall within subregion 120 may fall instead within subregion 232.

When a set of inputs lies within a subregion (such as subregion 232) that differs from another subregion (such as subregion 120), in light of this difference, an inferential model previously trained for subregion 120 may not provide accurate outputs for the set of inputs that fall within subregion 232. In certain embodiments of the present disclosure, a new inferential model may be trained on data that falls within subregion 232, and systems described herein may use that new inferential model whenever the system detects that data is being generated from the user in the vicinity of subregion 232. Accordingly, the disclosed systems can determine which models to employ, and when to employ them, to exhibit the most accurate level of complete control across different input modes and control schemes. In certain embodiments, disclosed systems may determine the distance(s) between the various subregions in the feature space (e.g., subregions 120 and 232) and may blend the outputs of the two models together to get an output that is invariant to one or more parameters (e.g., a 2D pointer output that is invariant to a first squeeze during performance of the 2D movements). For example, inputs with a loose first may provide a blend factor of (1, 0), directing the system to rely on the inferential model that was trained on (or otherwise adapted for) wrist movements with a loose fist. Similarly, inputs with a squeezed first may provide a blend factor of (0, 1), directing the system to rely on the inferential model that was trained on (or otherwise adapted for) wrist movements with a squeezed fist. Inputs that fall between subregions 120 and 232 (e.g., in terms of Mahalanobis distance) may provide a blend factor of (1-a, a), where a indicates the proportion of the distance of the inputs from subregion 120 as compared to the proportion of the distance of the inputs from subregion 232, directing the system to partially rely on each inferential model (or to combine the outputs of both inferential models to yield a final output). However, inputs that are far from both subregions 120 and 232 may yield a blend factor of (0, 0), directing the system to rely on neither the inferential model associated with subregion 120 nor the inferential model associated with subregion 232.

Accordingly, in certain embodiments, the system and methods disclosed herein can allow a user to exhibit 2D control with the same amount of precision and accuracy irrespective of the state of the user's hand (e.g., whether the user's hand is in a closed or open state). In other embodiments, the disclosed systems and methods can afford a user better control when selecting from one or more options presented in one or more locations within a virtual or on-screen 2D map. For example, different options can be presented to the user on the virtual or on-screen visualization, and the user can navigate to those options using 2D wrist rotation and select from the options by performing another hand gesture such as clenching the fist.

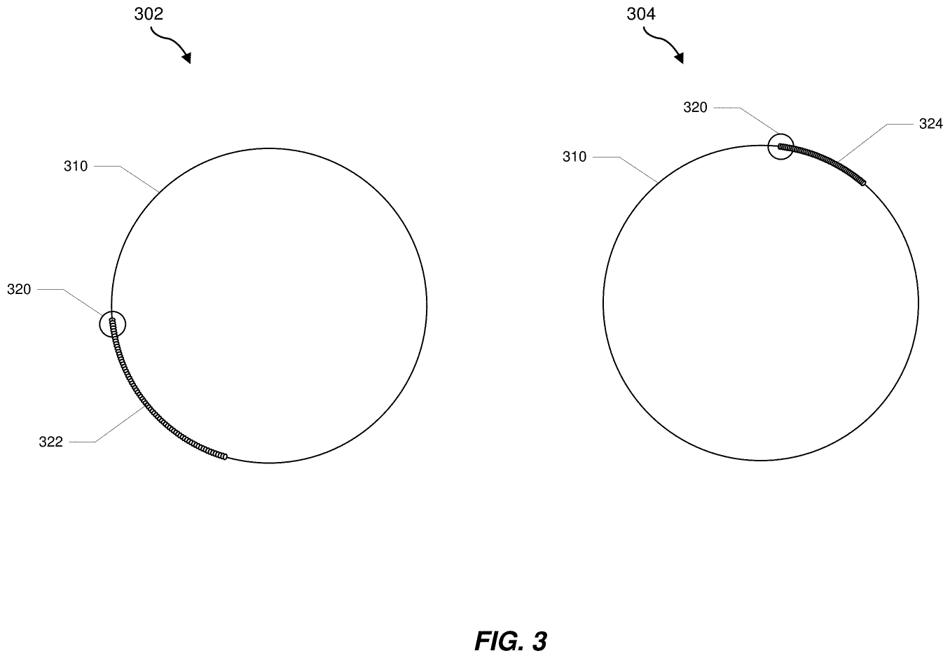

Further to the embodiments discussed herein, a 2D wrist rotation model may be trained using a loose first while making the wrist rotations. The subregions within the feature space can be determined and analyzed in this embodiment as follows. In a first step, the system may collect data, e.g., tangent space input features, while the user is using a loose first to train a 2D model, which may have previously been generated as a generalized model based on various users using a loose first during performance of 2D wrist movements. In this step, the user may be prompted make sure the unit circle is properly traversed and both fast and slow motions are used. By way of illustration, FIG. 3 shows an example graphical user interface for online training of an inference model for 2D movement via wrist rotation. As shown in FIG. 3, in a state 302, the graphical user interface includes a circle 310 for a cursor 320 to traverse. As the user rotates their wrist clockwise, cursor 320 traces a path 322 along circle 310. In a state 304, as the user rotates their wrist counterclockwise, cursor 320 traces a path 324 along circle 310.

In addition to training with a loose fist, a 2D wrist rotation model may be trained using a squeezed first while making the wrist rotations. For example, the system may collect data, e.g., tangent space input features, when the user makes a squeezed first to perform the same 2D training model as above. As discussed above, the user may be prompted to get a wide range of wrist motions that would cover unit circles and include both fast motion and slow motions.

After collecting data as described above, systems described herein may analyze the data. For example, for each data set (i.e., the data collected with a loose first and the data collected with a squeezed fist), the systems may compute the mean and the covariance of the data points. Additionally or alternatively, the systems may analyze the distances between data points using any of a variety of techniques, including: (i) a hyperplane of control; (ii) a one-class support vector machine with a Gaussian kernel that can distinguish between being in and out of the target region(s) in the feature space, as well as a distance of how far the data points are from the target region(s) for any given model; (iii) placing a margin between various data clusters and determine a blending factor based on signed distance to the margin, etc.; (iv) training neural networks to identify placement (or lack thereof) within the data sets and/or to distinguish between the data sets; and (v) performing a regression to model the data sets.

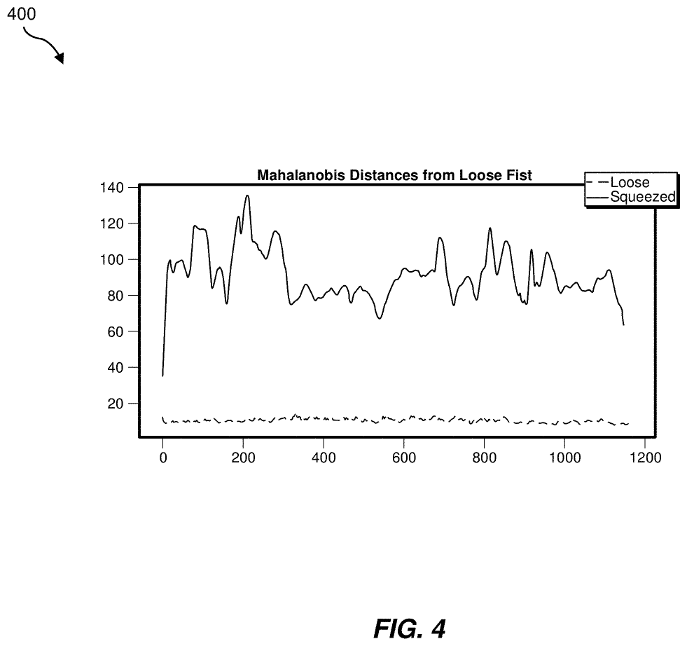

As an illustration of the difference in neuromuscular input data for wrist rotation between loose-fist and squeezed-fist scenarios, FIG. 4 shows a plot 400 comparing the distribution of data points used for training a loose-fist model and data points used for training a squeezed-fist model. As shown in FIG. 4, the Mahalanobis distances of loose-fist data points from the mean of the loose-fist cluster are consistently low, whereas the Mahalanobis distances of squeezed-fist data points from the mean of the loose-fist cluster are significant. As can be seen in FIG. 4, the two distributions vary statistically and/or structurally. The disclosed systems and methods may leverage this difference in the distributions to implement full control schemes using various inferential models.

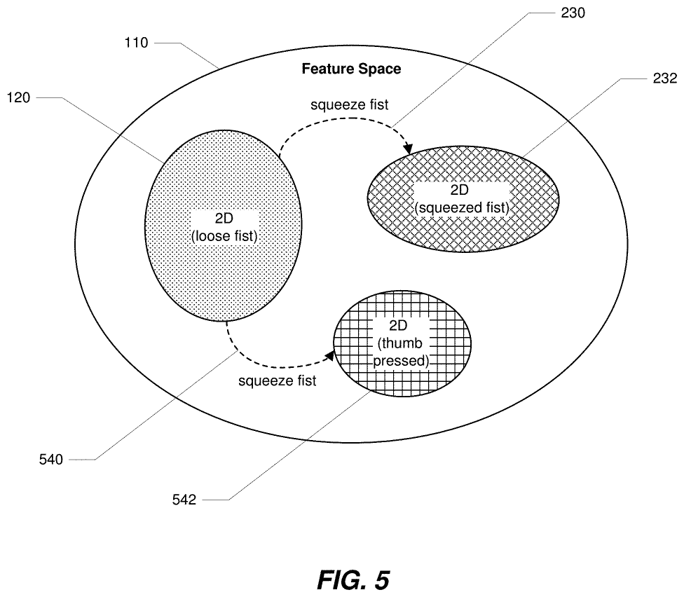

While, for simplicity, the discussion above has focused on one or two subregions within the feature space, in various examples there may be more than two subregions in the feature space (e.g., each with a corresponding inferential model trained on data points from within the respective subregion). For example, as described above in connection with FIGS. 1 and 2, a user could be performing wrist 2D movement with their first squeezed instead of loose. Likewise, a user could be performing the previously described wrist 2D movement with their thumb pressed against the fist. By way of illustration, FIG. 5 shows the feature space 110 of FIGS. 1-2 with a transition 540 from subregion 120 (where the user is moving their wrist while their first is loose) to a subregion 542 (where inputs are observed when the user is moving their wrist while their thumb is pressed). A thumb press could be used for a discrete/instantaneous event (e.g., to engage or disengage a particular feature within a given application), as well for a continuous/hold event (e.g., to maintain activation of a particular feature within a given application). In the case of a continuously held thumb press event, inputs (e.g., involving 2D movements of the wrist) that may otherwise normally fall within subregion 120 may fall instead within subregion 542.

The transitions between subregions as shown in FIG. 5 can be interpreted as discrete or unique events or different continuous events. For example, a discrete event can be a quick transition between regions and then back again, and a continuous event can include a scenario where the data collected lingers within a defined region of the feature space. In certain embodiments, the relationship between subregions within the feature space and interpretable representations of the feature space is utilized to implement the disclosed system and methods herein. In certain embodiments, the disclosed systems and methods map out subregions in the feature space and provide feedback to a user about which subregions the processed neuromuscular input data is residing in or traveling between.

In certain embodiments, the systems and methods disclosed herein allow for full control schemes by implementing blended linear functions. For example, the disclosed systems and methods can blend a “loose fist” 2D linear model and a “squeezed fist” 2D linear model as shown in Equation (1) below:

y=(1−α(x))Wₗₒₒₛₑx+α(x)W_{squeezed}x (1)

which can be rearranged as shown in Equation (2) below:

y=Wₗₒₒₛₑx+α(x)(W_{squeezed}−Wₗₒₒₛₑ)x (2)

or as shown in Equation (3) below:

y=Wₗₒₒₛₑx+α(x)W_{correction}x (3)

The second term on the right-hand side of Equation (3) can be interpreted as a correction which happens whenever the user exits the “loose fist” subregion for the collected data inputs in the feature space and moves towards the “squeezed fist” subregion.

In certain embodiments, systems described herein calculate the blending function (i.e., α(x)) and determine how much of the correction to apply, depending on where the input or inputs are within the feature space. In certain embodiments, the correction to be applied can be learned from data inputs and/or can be computed geometrically by projecting the action along the vector that connects the mean of the “loose fist” distribution to the mean of the “squeezed fist” distribution.

In another embodiment, the system and methods disclosed herein can employ one or more “contaminated” nonlinear models. Such a process may provide extra model capacity by first learning a linear model and then teaching a non-linear model to emulate the linear one. Once that is accomplished, the systems and methods disclosed herein can exploit the extra capacity in the nonlinear model to make it robust to the multiple regions in the feature space and transition between them. In some embodiments, the nonlinear model could be a neural network or any other model—e.g., a blended linear model in which the existing linear model is held fixed, but extra capacity is added by learning the blending function and corrections to some baseline model.

In various embodiments, the system and methods disclosed herein can adapt their data interpretations by turning off data input interpretations when certain data is not desired (e.g., not deemed suitable for a given inferential model). For example, if the system detects that the user is generating inputs that fall within a subregion of feature space not intended or desired for that given activity, the system can ignore those data inputs until they fall back within the subregion of interest in the feature space.

In some embodiments, the systems and methods described herein relate to processing, analyzing, visualizing, and training users based on neuromuscular signal data (e.g., sEMG data) obtained in a high-dimensional feature space and presenting that data in a lower dimensional feature space (e.g., two dimensional (2D) latent space). The systems and methods described herein may comprise training users via a visual interface of the latent space and presenting a mapping of detected and processed neuromuscular signal data. Using the described systems and methods, a user's performance (and a computer model's detection of that performance) can be improved for certain handstate configurations or poses as detected by one or more inferential models. Using a feedback loop, the user's poses can be more accurately classified by a machine control system. In certain embodiments, the system can further comprise a closed loop human-machine learning component wherein the user and computer are both provided with information regarding the received and processed neuromuscular signal data and a 2D latent space with latent vector plotting of the neuromuscular signal data. This approach allows the user to adjust their performance of handstate configurations (e.g., poses and gestures) and for the computer to more accurately classify the user's handstates into discrete poses and gestures based on one or more inferential models.

As discussed above, the systems and methods disclosed herein can provide feedback to the user regarding a feature space and how plotted vectors or data points within that feature space are being mapped. The feedback can come in any appropriate form, including but not limited to visual, haptic, and/or auditory feedback. The plotted points can be generated based on processed neuromuscular signal data. The neuromuscular signal data can be collected and processed during various time windows, as set by the system or the user for the task at hand. The plotted vectors or data points can be visually presented to the user and defined subregions within the feature space can be presented as well. The defined subregions in the feature space can correspond to subregions where a particular inference model produces the most accurate output(s) for processed neuromuscular data as inputs to the model. In an example embodiment, the user can be performing 2D control of a virtual cursor on a screen and may want to switch to various hand gestures to control the machine system. While the user is performing the 2D control via wrist rotations, they can visualize the subregion of the feature space into which their mapped vectors are falling. Once the user switches to performing a hand gesture (e.g., a finger pinch), the user can visualize the new subregion of the feature space into which their mapped vectors are now falling.

In some embodiments, the systems and methods described herein relate to detecting and processing a plurality of neuromuscular signal data from a higher-dimensional feature space into a lower-dimensional feature space including, but not limited to, a 2D latent space. In certain embodiments, a user receives feedback (e.g., in real-time or close to real-time) about how their neuromuscular data (sEMG data) is mapping onto or being presented or plotted within the lower-dimensional feature space, and how a machine learning inferential model is using position(s) in that the lower-dimensional feature space to extract event, gesture, or other control signal information. In one embodiment, visual feedback can be presented to the user such that the user can adjust neuromuscular activity and receive immediate feedback about how that change in output is reflected in the feature space mapping and how the machine learning inferential model is classifying certain handstates, events, poses, or gestures within the lower-dimensional feature space.

In certain embodiments, an events model that has been trained across multiple users (e.g., a generalized model) can be implemented to process and classify neuromuscular signal data (e.g., sEMG data) from a user into discrete events. The generalized model can comprise a generated feature space model including multiple vectors representing processed neuromuscular signal data. Such neuromuscular signal data can be acquired from users using a wrist/armband with EMG sensors as described herein. The vectors can be represented as latent vectors in a latent space model as further described below.

In certain embodiments, the neuromuscular signal data inputs from a user can be processed into their corresponding latent vectors, and the latent vectors can be presented in a lower-dimensional space. The various latent vectors can be mapped within latent classification regions in the lower-dimensional space, and the latent vectors can be associated with discrete classifications or classification identifiers. In some embodiments, each latent vector may include two values that can be mapped to x and y coordinates in a 2D visualization and represented as a latent vector point in the 2D visualization. Such a latent representation of processed neuromuscular signal data may provide useful information and may prove more informative for certain data sets compared to larger or more dimensioned vector spaces representing the neuromuscular signal data. For example, using the disclosed systems and methods, a user can be presented with one or more latent representations of their neuromuscular activity as feedback on a real-time basis using a 2D mapped visualization, and the user can adjust behavior and learn from the representations to generate more effective control signals to control, for example, a computing device. Providing a user with immediate feedback allows the user to understand how their neuromuscular activity is being interpreted by the machine model. The discrete classifications in the latent space can be defined and represented by the system in various ways. The latent vectors can correspond to various parameters, including discrete poses or gestures (e.g., fist, open hand), finite events (e.g., snapping or tapping a finger), and/or continuous gestures performed with varying levels of force (e.g., loose first versus tight fist). As described herein, the disclosed systems and methods can allow for a personalized and robust classification of a data set collected from a user during performance of any one or more actions corresponding to a desired set of parameters.

In an embodiment that involves classification of discrete user hand poses or gestures, processed neuromuscular signal data can be represented and visualized in a 2D latent space with latent vectors. The latent space can be generated such that any higher dimensioned data space can be visualized in a lower-dimensional space, e.g., by using any suitable encoder appropriate to the machine learning problem at hand. These encoders can be derived from various classes of problems, including auto-encoding, simple regression or classification, or other machine learning latent space generation techniques. In certain embodiments, the encoder(s) can be derived from a classification problem (e.g., classifying specific hand gestures) and a neural network can be trained to discriminate a finite number of poses of the hand (e.g., seven different poses of the hand). In this embodiment, the latent representation can be constrained to a lower-dimensional space (e.g., a two-dimensional space) before generating the actual classification of the data set. Any suitable loss function may be associated with the neural network, provided that the loss function remains constant across the various mappings in the latent space and classifications of processed neuromuscular input during any given user session. In one embodiment, the network used to generate the latent space and latent vectors is implemented using an autoencoder comprising a neural network and has a network architecture comprising a user embedding layer followed by a temporal convolution, followed by a multi-layer perceptron in order to reach the two-dimensional latent space. From the two-dimensional latent space, latent vectors can be mapped to classification probabilities for the seven classes via a final linear layer. As used herein, a “user embedding layer” comprises a vector unique to each user that defines a user-dependent transformation intended to adapt the model to the user's unique data characteristics (e.g., unique EMG data patterns for certain gestures performed by a user). The addition of such a unique vector can increase the reliability of the inferential model. This embedding layer can be determined via one or more personalized training procedures, which can tailor a generalized model by adjusting one or more of its weights based on processed EMG data as collected from the user during the performance of certain activities.

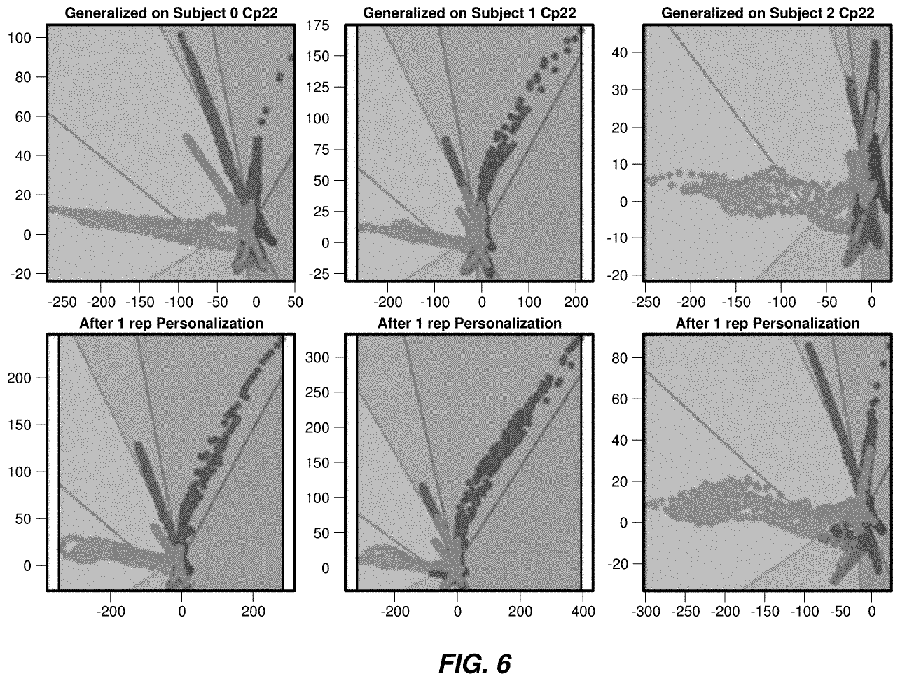

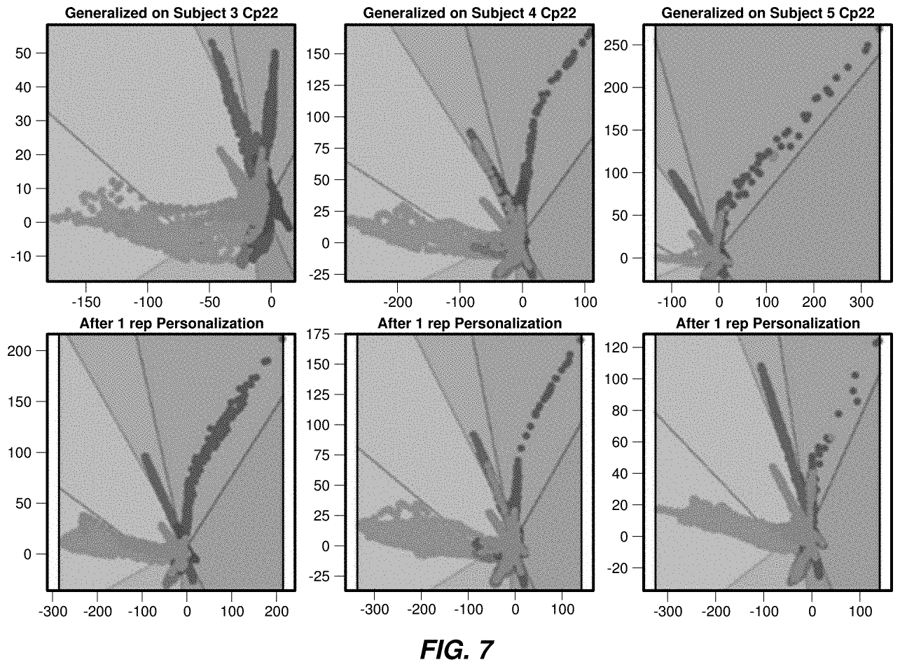

FIGS. 6 and 7 show example plots that are generated from collected and processed user neuromuscular data and that represent 2D visualizations of latent vectors representing classifications of users' hand poses. The plots represent various latent vector points and latent regions. In an exemplary embodiment, data was collected from 6 subjects during a session using a neuromuscular armband as disclosed herein. The latent vector points and plots generated for the 6 subjects (e.g., subjects 0-5) based on a generalized model are presented in the top rows of FIG. 6 and FIG. 7. Each of the 6 subjects performed one of seven hand poses sequentially, namely: (1) a resting hand (the active null state); (2) a closed fist; (3) an open hand; (4) an index finger to thumb pinch (“index pinch”); (5) a middle finger to thumb pinch (“middle pinch”); (6) a ring finger to thumb pinch (“ring pinch”); and (7) a pinky finger to thumb pinch (“pinky pinch”). The EMG signal data associated with those hand poses was collected, processed using a generalized model trained from data acquired from multiple users, and associated latent vectors were displayed onto a 2D representational latent space as shown in the top rows of FIG. 6A and FIG. 6B. Each of the seven classifications of poses can be seen based on different coloring in the 7 latent spaces. After the users performed the gestures using the generalized model, each of the 6 subjects underwent a guided training session where they were instructed to perform each of the seven poses in sequence over several repetitions, and EMG signal data was collected and processed to personalize classification models to better detect the specific user's poses. The latent vector points after training are shown in the bottom rows of FIG. 6 and FIG. 7. The bottom rows of FIG. 6 and FIG. 7 represent latent vector points generated after one session of personalized training.

As can be seen in FIGS. 6 and 7, the sizes of the latent spaces vary across users. After one session of personalized training, the latent spaces representing the seven classifications can be visualized as more uniform in size and the latent vectors can be seen as being appropriately pushed towards the right pose classifications (e.g., subjects 2 and 3). As reflected in the latent space visualizations, personalized training enables more uniformly sized classification zones. With more uniformly sized zones in the latent space, a user of the armband can better visualize and fit their mapped neuromuscular activity reliably in a classification zone as intended (as further described herein).

In some embodiments, the mapping into latent space positions for the various classifications can vary between individuals and between personalized models for a particular individual. The described systems and methods provide solutions to account for this variability across individuals and between personalized models for a given individual. In certain embodiments, real-time feedback can be presented to the user so the user can adjust their behavior to ensure that the latent vectors are mapped more closely together and/or within a defined portion of the latent space. This can allow the user to exert more accurate control over the machine whether they are using a generalized machine learning model or a personalized model. Such an embodiment with visual and other types of sensory feedback for improving user-machine control is discussed further below.

In other embodiments, visualizations of mapped latent vectors can be used to determine how effective a generalized model may be performing for any given user. If, for example, a user is performing a gesture repeatedly with the same amount of force, and the generalized model is mapping the vectors across a wide range of the latent space or region or within only a very small range of the latent space or region, then the generalized model may not be working well for that specific user in terms of output accuracy. In that instance, the systems and methods described herein would indicate to the user that they should train another model to better represent their neuromuscular activity in the machine control scheme. Using the described systems and methods, one can infer a model is working well for a specific user if the latent vector regions are clearly separable in the latent vector space.

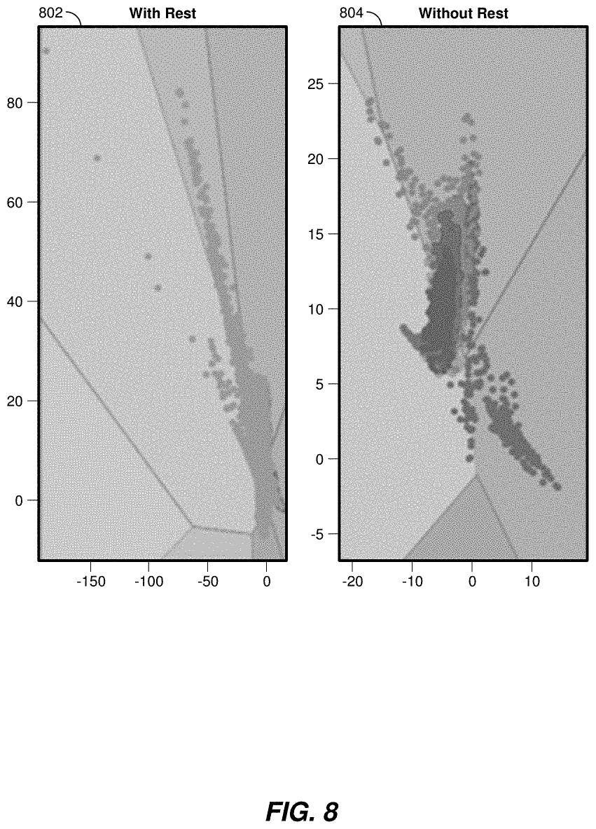

In certain embodiments, the systems and methods disclosed herein can be used for error diagnosis for a data set. For example, the disclosed systems and methods can be used to analyze and understand that a particular collected data set (e.g., processed EMG signal data) has bad metrics associated with it. By way of an exemplary embodiment, EMG signal data was collected and processed from a subject performing the seven poses as described above, either with or without rest between poses. The processed data is represented and depicted in FIG. 8. Plot 802 represents latent vectors associated with user rest between poses and plot 804 represents latent vectors associated with no rest between poses.

As seen in FIG. 8, as compared to the training and validation subjects from the same experiment, this dataset has a very small domain in the projected space, and further that the rest class contains a great deal of information. Given that the latent vectors are being mapped into a very small domain in FIG. 8, it can be deduced that the specific model used for that person was not optimal for that individual and that another model can be tried for that individual to improve accuracy. Further, if this phenomenon was observed across multiple users, then one can deduce that the model is not performing well across users and the model therefore needs to be inspected further. In certain embodiments, this 2D visualization can be systematically generated across users and/or across sessions to systemically monitor model performance for a given user or a set of users.

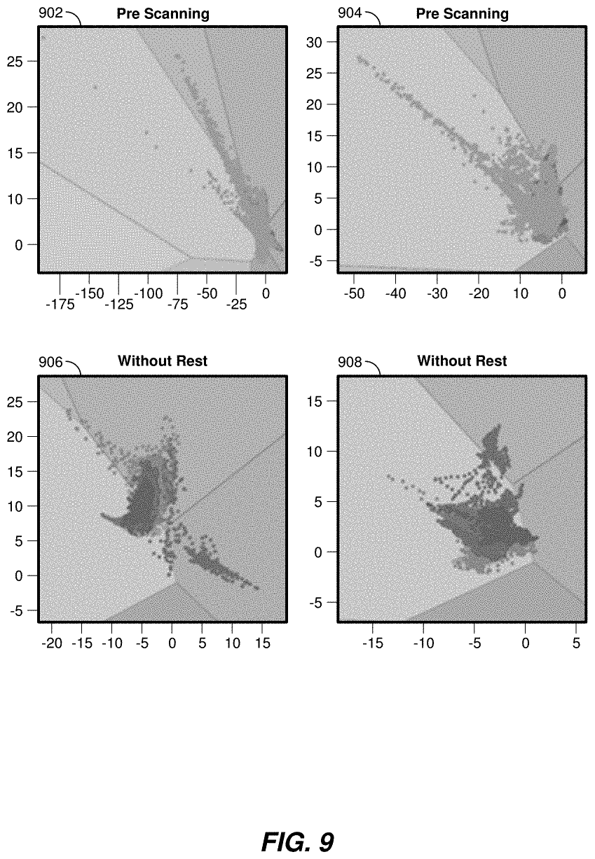

To visualize how personalization of poses using a training module affects a low-dimensional model as generated according to an embodiment, visualizations shown in FIG. 9 can be generated. Plot 902 represents a latent vector representation using a generalized pose model. Plot 904 represents a latent vector representation using a personalized pose model. Plot 906 represents a latent vector representation using the generalized model without rest between poses. Plot 908 represents a latent vector representation using the personalized model without rest between poses.

As can be seen in FIG. 9, the 2D model provides useful insight into how the system is classifying the various user poses. As can be seen, this pathology in the representation as viewed with the generalized model appears to be related to poor personalization. In this particular example, one can deduce that the model is not performing well for this specific user, and that the model may have been inadequately trained or trained on an improper data set. Further, one can rule out any user behavioral errors during performance of the tasks based on the narrowly defined region in which the latent vectors were falling. That the model congregated data points into a more concentrated region suggests the model is deficient in some respect. Such information can be used to reassess the sufficiency of the model, including by looking at the underlying data quality fed into the model and possibly diagnose any underfitting or overfitting of data by the model.

In another embodiment, the systems and methods described herein comprise an interactive feedback loop to provide feedback to the user. The system and methods can also comprise a closed loop human-machine learning configuration, wherein regions of a 2D latent space are defined and associated with certain classifications (e.g., hand poses or gestures), finite events (e.g., snapping or tapping a finger), and/or continuous gestures performed with varying levels of force (e.g., loose first versus tight fist). In various embodiments, the system can provide visual feedback to the user during a user's performance of activities as they are sensed in real-time through neuromuscular EMG sensors. For example, if the user is making an index finger to thumb pinch, the system can present a user interface showing a latent space representation of that gesture. As the user makes each of the discrete pinches, a vector associated with that activity can be plotted as a data point on the screen. The various regions of the latent space can be labeled so that the user can identify the regions and associate them with the activities. In certain embodiments, the various regions of the latent space can be labeled with text or images that show the gesture in the region. For example, each region can illustrate a different finger pinch or handstate configuration. Alternatively, each region can be labeled using a color-coded legend shown to the side of the latent space visualization or any other legend or key associated with specific finger pinches and handstate configurations. In certain embodiments, the user can visualize their previous gestures more saliently in order to track their progress. For example, more recent data mappings can be shown in different colors (hues and saturations, opacity levels or transparency levels, etc.) or with special effects or animations (e.g., comet trails, blinking/flashing, blinds, dissolving, checkerboxes, sizing alterations, etc.). Certain embodiments can also include auditory or haptic feedback in addition to visual feedback. Such embodiments can include auditory sound effects or haptic feedback to designate the various classifications or a transition from one classification to another (e.g., beeps or vibrations for every single mapped point or only when a mapped point goes into another latent region based on the previously mapped region). In one embodiment, if a user is performing a first gesture and a second gesture is mapped to a region in the latent space adjacent to the region of the latent space associated with the first gesture, the system can present a visual indicator showing the user that their data mappings are getting close to the adjacent region or are starting to fall within the adjacent region (e.g., highlighting a boundary between two latent regions). In various embodiments, the latent regions for the visual display can be assigned using a variety of labeling techniques, which include but are not limited to arbitrary labels; selectable or modifiable labels that the user can toggle through; visual depictions, logos, or images; slightly visible or invisible labels associated with auditory and/or haptic feedback or other types of sensory feedback. The user may toggle through or select from various labels by providing neuromuscular input (e.g., snapping, flicking, etc.) and/or voice input (e.g., oral commands) into the system. In certain embodiments, the user can assign custom labels either before or during mapping of the latent vector points.

In certain embodiments, if the user repeatedly performs an index finger pinch and the user notices that the visualization displays points for each of the index finger pinches in a latent region associated with a different classification (e.g., a pinky finger pinch), the user can perform model personalization based on that specific gesture (or a combination of gestures) to better personalize their model and more accurately detect that specific gesture (or a combination of gestures).

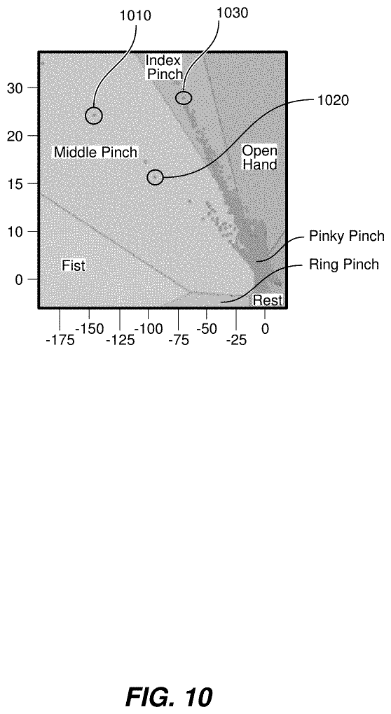

In an embodiment where the user is trained using the systems and methods described herein, the latent regions can be labeled based on the expected hand gesture to be classified. For instance, the latent regions may be labeled as “Index Pinch,” “Middle Pinch,” etc., as shown, for example, in FIG. 10. FIG. 10 depicts a labeled latent space with hand pose classifications and vectors represented as data points during user training.

As the user makes a middle finger to thumb pinch, data point 1010 circled in FIG. 10 can be displayed. If the user performs the middle finger to thumb pinch again, data point 1020 circled in FIG. 10 can be displayed. If the user then performs an index finger to thumb pinch, data point 1030 circled in FIG. 10 can be displayed. In this way, the system can provide real-time visual feedback to the user as to how the system is analyzing, mapping, and classifying the various processed EMG signal inputs. If a user performs a middle pinch, but the data point appears in the index pinch latent space or appears close to the line separating the two latent spaces, the user can adjust how they are performing their index finger to thumb pinch and their middle finger to thumb pinch in order to adapt to the machine learning algorithm model being employed by the system. For example, if the user rotates their wrist slightly in either the clockwise or counter-clockwise direction, and the user sees how that wrist rotation affects the system's mapping and/or classification of their pinches, the user can adapt their wrist rotation as appropriate for the system to accurately identify the user's pinches.

In another embodiment, the system is able to detect and account for the user changing the position of their wrist while performing a gesture repeatedly. For example, a user can perform an index pinch and the system can properly classify the pinch and associate and plot a corresponding first latent vector that can be presented to the user. The user can instruct the system that it is going to perform the same gesture again. When the user performs the gesture again, they can do so with a slight modification (e.g., different wrist angle or degree of rotation). Based on the processed EMG data for that second gesture, the system can associate and plot a corresponding second latent vector that can be presented to the user. The system can quantify the distance between the first and second latent vectors and use that calculation to improve its ability to detect that specific gesture classification.

In another embodiment, the disclosed systems and methods can improve their personalization models by analyzing training data and remapping the classification boundaries within the latent space based on that training data. For example, if a user notifies the system about its next intended pose of an index pinch (or the system instructs the user to perform an index pinch), the system can modify the size and spacing of the latent spaces associated with index pinch (and the other classifications) if a mapped latent vector falls outside of the designated latent region for the index pinch classification.

In another embodiment, the user can repeatedly perform middle finger to thumb pinches while rotating their wrist in both clockwise and counterclockwise directions while aiming to maintain all of the associated data points within the defined middle finger to thumb latent space. As the user is performing this activity, the system can detect that pattern (either on its own in an unsupervised learning fashion or can be told that the user is going to perform the various rotations of the pinch in a supervised learning fashion) and learn to process the additional data associated with the wrist rotation and either account for or ignore certain data when it is trying to determine if the user is performing the middle finger to thumb pinch. In this way, the disclosed systems and methods can learn and generate more personalized models for each individual user.

In another embodiment, the user can be presented with an instruction screen instructing the user to perform only an index finger to thumb pinch, and the system can be instructed to recognize only index finger to thumb pinches and present those latent vectors to the user during the training session. If the system processes an EMG neuromuscular data input and initially associates a vector with that input that falls outside of the designated latent space for that classification, the system can learn from that EMG neuromuscular input and re-classify that input by associating it with the proper, designated classification. This can be an iterative process until the system reliably classifies the neuromuscular input data into the correct latent spaces and thus classifications. The degree of reliability of classification can be set by the user, e.g. 80% accurate hit rate, 90% accurate hit rate, etc.

As described above, the various modes of feedback to the user during a training session can vary depending on session training goals and how well the user is responding to the various types of feedback. In addition to the types of feedback mentioned above, additional types of feedback may be provided using extended reality systems and devices such as virtual reality and augmented reality devices. In these implementations, the latent visualizations can be presented to the user in an immersive or augmented environment where the training can be executed in a more user friendly and efficient fashion. Any of the above-described sensory indicators can be presented in virtual or augmented environments with the appropriate accessory hardware devices, including head-mounted displays and smart glasses.

In various embodiments, the subregions of the 2D latent representations as described with respect to FIGS. 6-10 may correspond with differing subregions in a feature space as described with respect to FIGS. 1, 2, and 5. Accordingly, systems described herein may apply differing inferential models to inputs falling in the various respective subregions of the 2D latent representations. Furthermore, in those embodiments in which subregions of the 2D latent representations are adjusted in response to user feedback, boundaries within the feature space delineating the use of differing inferential models may likewise be adjusted.

In another example embodiment, the systems and methods disclosed herein can be used to assess the efficacy of a particular inferential model. A user could be performing a hand gesture such as an index finger to thumb pinch and then can hold that pinch by rotating their wrist. In an embodiment, the visualization presented to the user can show mapped vectors or data points in a well-defined region with the pinching gesture when the wrist is in a neutral position, and as the user rotates their wrist while holding the pinching gesture, the mapped vectors can start to appear at the periphery of the previously well-defined region and/or may begin to exit the previously well-defined region altogether. The ability to visualize this transition from neuromuscular inputs that are interpreted well by the inferential model to neuromuscular inputs that are not interpreted well by the same inferential model would allow the user to modify their behavior to better fit the inferential model. In this example, if there is a specific range of wrist rotational angles that result in mapped vector points residing within the defined subregion, and other wrist rotational angles that result in mapped vector points falling outside of that sub-region, the user will know to stay within a certain range of rotation angles to best maximize their ability to control the machine via the inferential model. The ability to visualize the point(s) at which the quality of the outputs of the inferential model begin to deteriorate can be used to fine-tune the inferential model. For example, additional neuromuscular inputs can be fed into the inferential model to better train that model under certain scenarios and/or circumstances. Alternatively, the limits of any particular inferential model can be visualized such that the limits of the inferential model can be assessed and another inferential model can be trained on those data points that did not result in quality outputs from the first inferential model.

In certain embodiments, a plurality of inferential models can be trained on more limited sets of data. For example, inferential models can be trained and thus specialized and more accurate in detecting certain patterns of neuromuscular activity (e.g. forces, movements, Motor Unit Action Potentials, gestures, poses, etc.). Each of the inferential models can be implemented as part of the disclosed systems and methods herein such that accurate detection and/or classification of the neuromuscular activity can be improved by the selective application of one of the inferential models. In such an exemplary embodiment, there could be four inferential models trained on robust data sets to detect each of the finger pinches (e.g., one robust inferential model for the index finger to thumb pinch, another robust inferential model for the middle finger to thumb pinch, etc.). Depending on which pinch the user is performing, the systems and methods disclosed herein could select the appropriate inferential model into which to feed the processed neuromuscular data. Such a setup may result in more accuracy and greater flexibility in adding and updating models than a single model trained to detect all four hand gestures.

The various inferential models can be organized based on various input modes or control schemes. Such input modes and control schemes can comprise one or more of the following: user handstate configurations, hand poses, hand gestures (discrete and continuous), finger taps, wrist rotations, and varying levels of forces being applied during the performance of any one or more of the foregoing; typing actions from the user; pointing actions; drawing actions from the user; and other events or actions that can be performed by the user or detected by the systems disclosed herein.

In order to train and produce the various inferential models that correspond to the various input models and control schemes that the systems described herein may implement, systems described herein may gather user neuromuscular data. In some implementations, a user can be presented with an online training application. The online training application loads a Graphical User Interface (GUI) operatively coupled to the wearable system via, for example, Bluetooth. A user can select from a set of online training tasks provided by the GUI. One example of such an interface may be the interface illustrated in FIG. 3. Although the discussion of FIG. 3 centered around control based on wrist rotation, a similar interface may be used for training other control schemes, such as the user controlling a cursor within a 2D plane with the tip of their finger. For example, users can wear the wearable device in their right wrist or arm and select a first training task in which users are prompted to drag a cursor within the interface along the edge of a circle with, for example, the tip of their finger on their right hand. The wearable device records EMG signals from users while they perform the training task such user data is saved to later train the user-specific machine learning model.

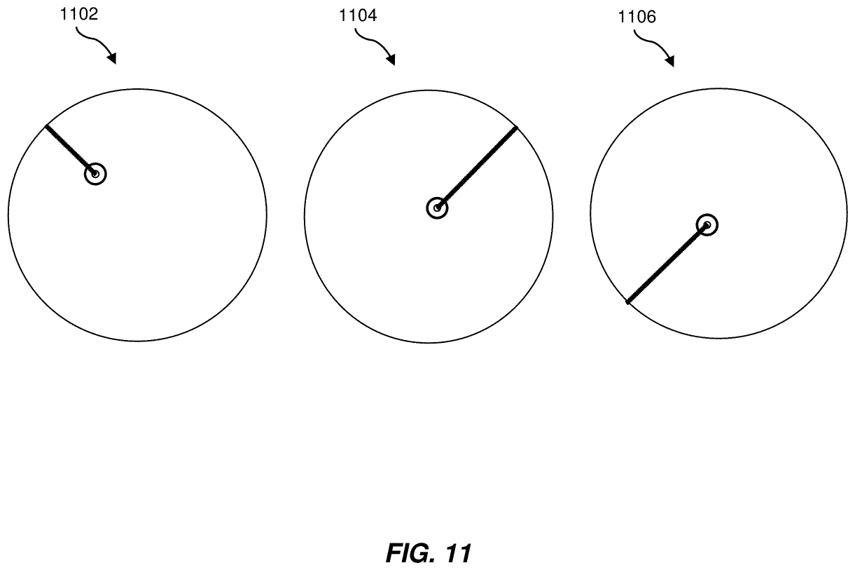

Likewise, users can select a second training task in which users are prompted via the GUI to move a cursor from within a circle to the edge of the circle as shown in FIG. 11. For example, in state 1102 of the interface, a user may drag the cursor diagonally up and to the left to the edge of the circle. In state 1104 of the interface, a user may drag the cursor diagonally up and to the right to the edge of the circle. In state 1106 of the interface, a user may drag the cursor diagonally down and to the left to the edge of the circle.

As in the previously described training task, the wearable device records EMG signals from users while they perform the training task such users' data is saved to later train the user-specific machine learning model. Such user data is saved and used to train a user-specific inference model. The protocols described above can be used to train a user-specific inference model without the need of having predefined ground truth data. Thus, the ground truth data is generated via one or more of the available training protocols based on user-specific data. Accordingly, some memory resources can be saved by not relying and having in memory predefined ground truth data that may be larger than the user-specific data. In addition, the generation of the user-specific inference model may be perceived by users as near-instantaneous, i.e., the users can start using the armband device with the user-specific inference model rapidly after providing the user-specific data. In some instances, the training of the user-specific inference model can be executed in the user's local machine while in other instances, the training of the specific inference model can be executed remotely in the cloud.

Some individuals may be limited in the type of movements (or extent of forces) they can generate with a part of their body for any of various reasons including but not limited to: muscle fatigue, muscular atrophy, injury, neuropathy, repetitive stress injury such as carpal tunnel disorder, other peripheral nerve disorder (including degenerative nerve disorders such as multiple sclerosis or ALS), motor disorder of the central nervous system, chronic fatigue syndrome, deformity or other atypical anatomy, or other health-related reasons. Thus, the training and implementation of user-specific inference models for two-dimensional control are particularly well-suited to individuals whose motor system and/or anatomy is atypical. In some embodiments, a user-specific inference model may be periodically assessed to determine whether a user's ability to perform the movements and/or forces used to train (and/or retrain) a user-specific inference model are no longer feasible. This may occur, for example, if a user's injury resolves and his or her range of motion increases, thereby affecting the quality of the user-specific inference model trained during a time when the user's range of motion was reduced (e.g. due to injury). The systems and methods described herein may be configured to automatically detect the increased error rates of the model and cause a user interface to be presented to re-train the subject. Similarly, the systems and methods described herein may be further configured for a user who indicates that they have a neurodegenerative or muscular atrophy condition, thereby causing a user interface for retraining the user-specific inference model to be presented from time-to-time.

In some implementations a linear model can be used to implement the user-specific machine learning model. A linear model was selected because it is a good choice in cases in which the input data is such that the various classes are approximately linearly separated however, other models such as deep feed forward network, convolutional neural network, and recurrent neural network can likewise be selected.

Some human computer interfaces rely on generic inference models trained by aggregating data from multiple users. Such systems may reach an accuracy and performance plateau in part because the performance of generic models usually grows logarithmically with the number of training users. Moreover, in at least some cases it is unlikely that a certain type of generic model would reach the same accuracy and performance as a user-specific model. The examples provided below are in the context of a linear regression inference model. However, similar user-specific models can be implemented using various model architectures including but not limited to, a multilayer perceptron, a deep neural network (e.g., convolutional neural networks, recurrent neural networks, etc.), or other suitable type of prediction models.

In some instances, a linear model can be used to implement the user-specific inference model. A linear model is an adequate choice in cases in which the input data and the required model are approximately linearly related. Linear models describe one or more continuous response variables as a function of one or more predictor variables. Such a linear model can be implemented via linear regression, a support vector machine, or other suitable method or architecture. The hypothesis of multivariate linear model between n input variables and m output variables can be given (using vector and matrix notation) by Equation (4) below:

$${h}_{θ} ( x ) = {Θ}^{T} x + {θ}_{0} \\ Where \text{:} \\ Θ = [ \begin{matrix}{θ}_{11} & ⋯ & {θ}_{1 m} \\ ⋮ & ⋱ & ⋮ \\ {θ}_{n 1} & ⋯ & {θ}_{nm}\end{matrix} ] ∈ {ℛ}^{n \times m} , {h}_{θ} , {θ}_{0} ∈ {ℛ}^{m} , χ ∈ {ℛ}^{n} \qquad ( 4 )$$

It is noted that the above expressions correspond to multivariate linear regression models however, an analogous approach can be applied in the case of univariate linear regression. The cost function for multiple features is given by Equation (5) below:

$$J ( Θ , {θ}_{0} ; \{ {x}_{t} , {y}_{t} \} ) = \frac{1}{2 T} {\sum }_{t = 1}^{T} {\vert {h}_{θ} ( {x}_{t} ) - {y}_{t} \vert}^{2} \qquad ( 5 )$$

The cost J can be minimized with respect to parameters Θ and θ₀. Various regularization schemes may be applied to optimize the model to enhance robustness to noise and procure an early stopping of the training to avoid overfitting of the inference model.

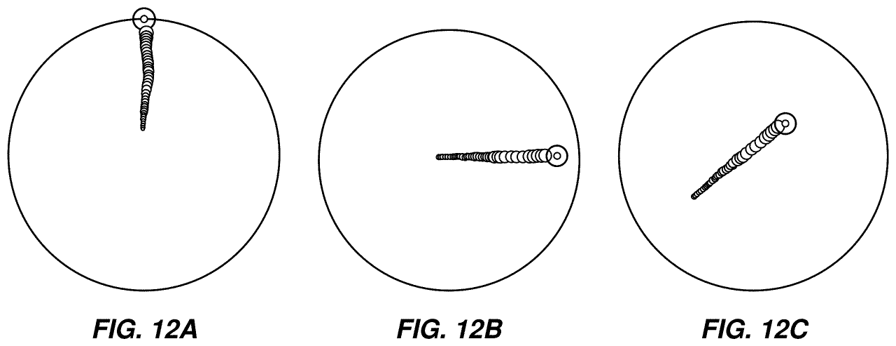

The above computations can be applied to build a user-specific machine learning model that takes as input EMG signals via the wearable device and outputs a set of numerical coordinates that can be mapped to a two-dimensional space. For example, the user-specific machine learning model can be used to predict, based on movements, hand poses, gestures, and/or forces, cursor positions within a graphical interface, effectively replacing a mouse, D pad, or similar peripheral devices. For example, a user may control a cursor rendered within a 2D graphical interface with the wearable device because the wearable device is configured (after the online training) to convert neuromuscular signals into X and Y cursor positions (control signals). Users can move the cursor within the 2D interface space by, for example, moving their fingers up, down, left, right, in diagonal, or other suitable movement as shown in FIGS. 12A-12C. The suitable movement may be idiosyncratic or unique to a user based on their comfort and preference.

Notably, non-linear models can be analogously implemented to incorporate additional features to the user-specific model, for instance clicking on a graphical object in two dimensional space (i.e. a button or hyperlink on a webpage), activating widgets, or other analogous operations that can be performed with additional functional interactive elements present in the user interface.

In some implementations, one or more various filters can be used to filter noisy signals for high precision and responsiveness. The filters can be applied to address temporal and/or spatial parameters of collected neuromuscular signals. For example, a one Euro filter can be implemented with a first order low-pass filter with an adaptive cutoff frequency: at low velocity, a low cutoff frequency (also known as corner frequency or break frequency) stabilizes the signal by reducing jitter. As the velocity of a control signal (e.g. for a cursor in 2D space) increases, the cutoff is increased to reduce lag. A one Euro filter can adapt a cutoff frequency of a low-pass filter for each new sample according to an estimate of a signal's velocity (second order), more generally its derivative value. The filter can be implemented using exponential smoothing as shown in Formula (6):

[symbol]

=X₁

\hat{X}₁=αXᵢ+(1−α) [symbol] ,i≥2 (6)

where the smoothing factor α∈[0,1], instead of being constant, is adaptive, i.e., dynamically computed using information about the rate of change (velocity) of the signal. This aims to balance the jitter versus lag trade-off because a user may be more sensitive to jitter at low velocity and more sensitive to lag at high velocity. The smoothing factor can be defined as shown in Equation (7):

$$α = \frac{1}{1 + \frac{τ}{{T}_{e}}} \qquad ( 7 )$$

where Tₑ is the sampling period computed from the time difference between the EMG samples, Tₑ equals (Tᵢ−Tᵢ₋₁), and τ is a time constant computed using the cutoff frequency

$$τ = \frac{1}{2 π {f}_{C}} .$$

The cutoff frequency f_{C} is designed to increase linearly as the rate of change (i.e., velocity), increases as shown in Equation (8):

f_{C}=f_{C}_{ₘᵢₙ}+β [symbol] (8)

where f_{C}_{ₘᵢₙ}>0 is the minimum cutoff frequency, β>0 is the velocity coefficient and \hat{\dot{X}}₁ is the filtered rate of change. The rate of change \hat{X}₁ is defined as the discrete derivative of the signal expressed in terms of Formula (9):

$${\dot{X}}_{1} = 0 \\ {\dot{X}}_{l} = \frac{{X}_{i} -}{{T}_{e}} , i \geq 2 , \qquad ( 9 )$$

The above may then be filtered using exponential smoothing with a constant cutoff frequency f_{C}_{_{d}}, which can be by default f_{C}_{_{d}}=1. Accordingly, a one Euro filter can be implemented to enable users to control, for example, graphical objects rendered in a two-dimensional space at a velocity proportional to the velocity at which users perform gestures while wearing the armband system (e.g., moving a hand from left to right and vice versa). In other embodiments, the signal can be further subjected to a leaky integrator in order to keep the responsiveness of the signal to spikes in activity while controlling the amount of time the signal is high.

After the user-specific inference model is trained, the system can execute self-performance evaluations. Such self-performance evaluations can be executed by predicting via the user-specific inference model a set of positions or coordinates in a two-dimensional space using as input a set of neuromuscular signals (e.g., EMG signals) known to be associated with a predetermined path or shape. Accordingly, a fitness level or accuracy of the user-specific inference model can be determined by comparing the shape or path denoted by the set of positions or coordinates with the predetermined shape. When the denoted shape departs or deviates from the predetermined shape or path, it can be inferred that the user-specific inference model needs to be retrained or needs further tuning. The system then provides, depending on determined fitness or accuracy deficiencies, a subsequent training task to retrain or tune the user-specific inference model with user data acquired via the subsequent training task.

In some implementations, the self-performance evaluation can be executed while the user is, for example, interacting with an application or game. In such a case, the system can determine accuracy or fitness levels by establishing whether the model predictions match movements or actions expected to be performed by a user. For instance, if a user is expected to perform a gesture wearing the armband system (e.g., perform a gesture to move a cursor to an upper left quadrant in a two dimensional space) the system can determine whether the user-specific inference model predicts, based on the neuromuscular signals received from the armband system, whether the cursor is rendered in the expected position. In some instance, when the expected position is different from the actual position, the system can conclude that the user-specific inference model needs to be further tuned or retrained. As discussed above, the system can provide a subsequent training task for the user which may be designed to specifically retrain the aspects of the user-specific inference model for which errors above a threshold value were identified. New user neuromuscular data acquired by the subsequent training task can then be used to retrain or further tune the user-specific inference model.

In some embodiments, a graphical user interface is provided to calculate a set of metrics that can be used to evaluate the quality of the user-specific model. Such metrics can include path efficiency, stability, consistency, reachability, combinatorics, and other suitable metrics.

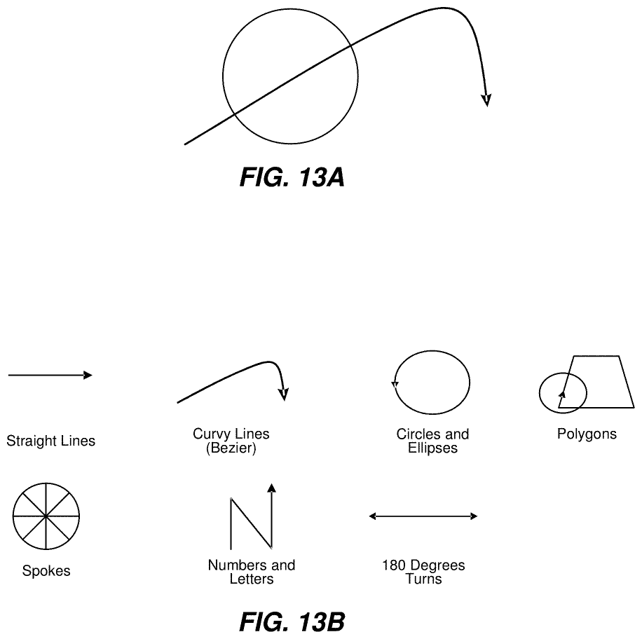

By way of illustration, FIG. 13A shows a visual representation of a path efficiency metric. In some implementations, path efficiency metrics can be computed by displaying on the GUI a path, for example, the arrowed path shown in FIG. 13A and instructing users to follow the path via movements including (finger movements, hand movements, wrist movements) while wearing an armband system. Such movements will cause a cursor indicator (circle) to move in the two-dimensional space defined by the GUI. Path efficiency can be measured as a function of the difference between the arrowed path and the path drawn by cursor indicator (while controlled by a user) on the two-dimensional space. In other words, a strong path efficiency metric value is associated with user movements that follow the displayed path while a weak path efficiency metric value is associated with user movements that depart from the displayed path. Other configurations different from the example provided in FIG. 13A are shown with respect to FIG. 13B below which shows different path forms.

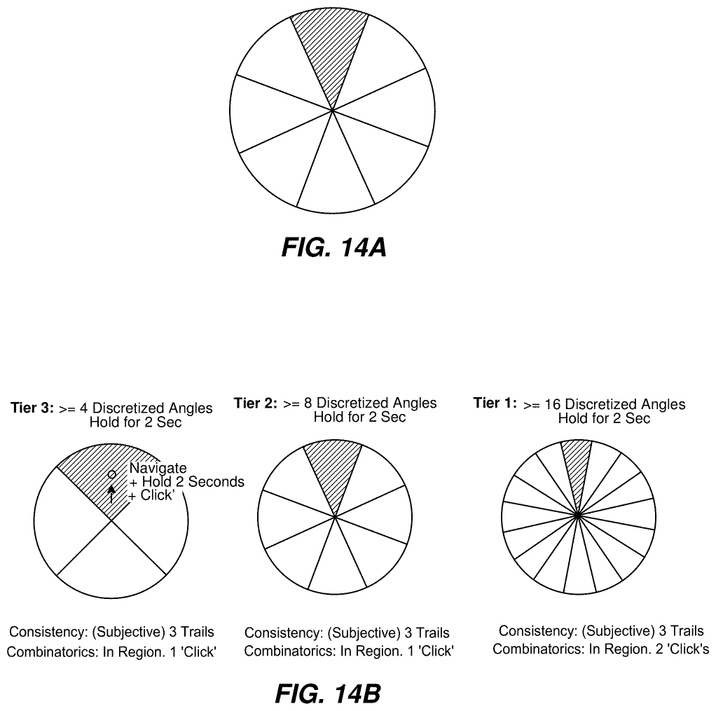

In some embodiments, stability metrics can be computed by displaying on the GUI a circle shape divided in a predetermined number of sections or slices as shown in FIG. 14A. In some instances, users can be prompted to hover a cursor over a particular circle section using the armband system that records neuromuscular data and inputs those data into a trained user-specific model for two-dimensional control. Stability metrics can be produced by measuring whether a user hovers over an indicated section. In some other instances, users can be prompted to hover over a particular circle section and hold the cursor in such a section for a duration that exceeds a predetermined amount of time. In such a case, stability is measured as a function of whether the user is able to hover over the indicated target section and whether the user held the cursor over the indicated circle section for the required time. FIG. 14B illustrates different GUI configurations that can be displayed for the user to compute stability metric values.

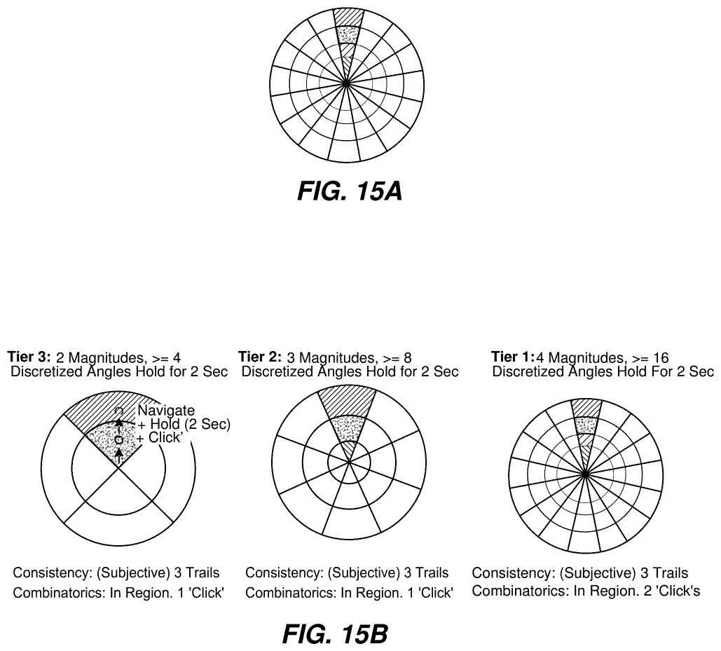

In some embodiments, reachability metrics can be computed by displaying on the GUI a circle shape divided in a predetermined number of sections as shown in FIG. 15A. In some instances, users can be prompted to hover a cursor over a particular circle section using the armband system. Reachability metric values can be computed by determining the number of indicated sections (i.e. sections of a slice at particular distances from the center of a target circle) a user is able to successfully reach. The example shown in FIG. 15A shows a circle divided into 64 sections of different sizes. For example, the circle can be analogously divided into fewer or more sections. It is understood that sections located closer to the center of the circle may be more difficult to be reached. Accordingly, a user's ability to successfully reach such sections represents a higher reachability metric value. FIG. 15B illustrates different GUI configurations that can be displayed for the user to compute different reachability metric values.

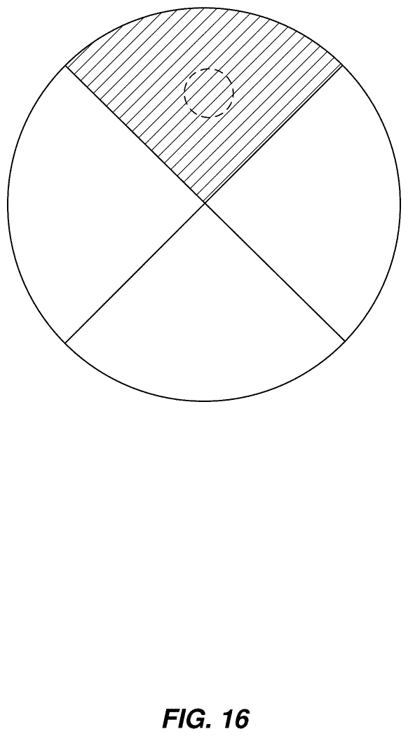

In some embodiments, combinatorics metrics can be computed by displaying on the GUI a circle shape divided in a predetermined number of sections as shown in FIG. 16. In some instances, users can be prompted to hover a cursor over a particular circle section using the armband system and perform a hand gesture, or hand or arm movement, of by applying a force corresponding to a click. Combinatoric metric values can be computed as a function of whether a task has been accomplished successfully. For example, the user may receive a positive value when the user successfully navigates to the indicated section and performs a click. In another example, the user may receive a partial score value when the user only succeeds at hovering the cursor over the indicated circle section but does not succeed at clicking on the circle section.

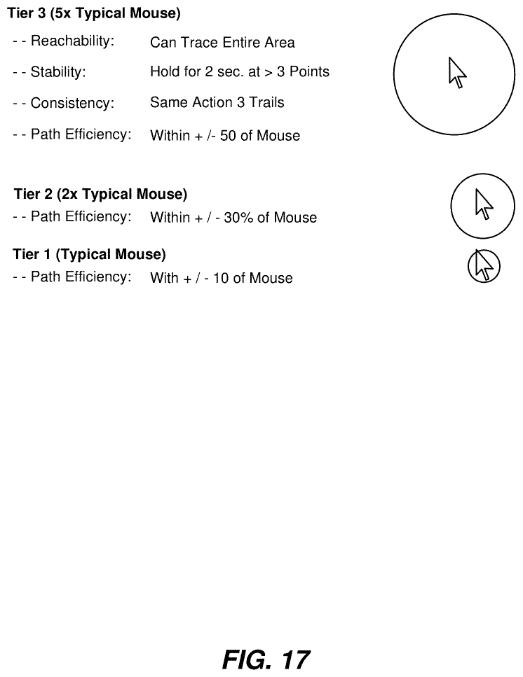

In some implementations, a further level of granularity to compute the metrics described above can be implemented by providing cursor indicators that vary in size as shown with respect to FIG. 17.

One skilled in the art will recognize that any target area shape and configuration of target sections within the shape may be used to assess stability, reachability, combinatorics, or another metric for effective two-dimensional control based on neuromuscular data and a trained user-specific inference model.

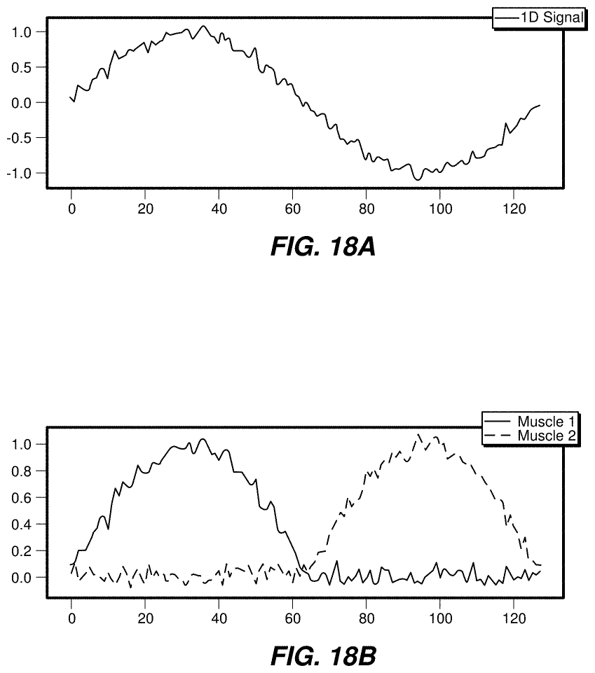

While the present disclosure largely represents the feature spaces described herein as two-dimensional for simplicity, feature spaces may have any suitable dimensionality based on any of a variety of variables. In one example, a dimension of the feature space may correspond to the activation of a muscle and/or to a pair of opposing muscles (which, e.g., may not typically be active simultaneously). For example, a continuous 1D output could be generated by two muscles, one which controls the positive dimension, and one which controls the negative dimension. By way of example, FIG. 18A illustrates a plot of a continuous 1D output representing the activation of a pair of opposing muscles. FIG. 18B illustrates a plot of the activation of each of the pair of the opposing muscles separately. Similarly, a continuous 2D output could may be generated with four muscles (two pairs of opposing muscles).

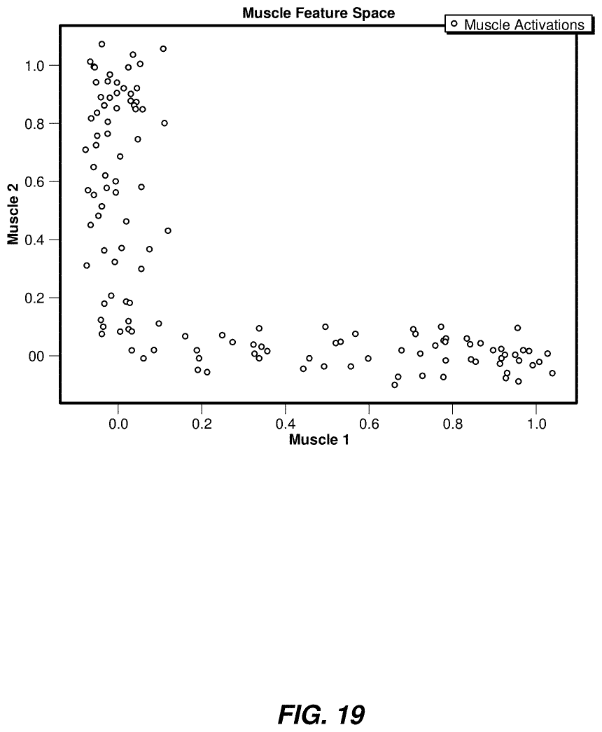

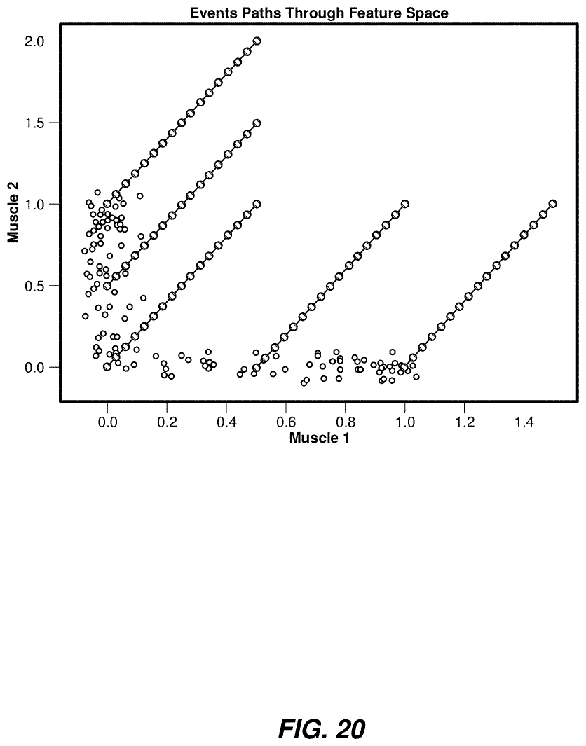

Continuing the example above, systems described herein may map and/or plot the samples of neuromuscular activity that generate the 1D signal to a feature space, as illustrated in FIG. 19. This may result in a subregion of expected neuromuscular data (e.g., representing cases in which only one of the pair of muscles is activated at any given time). However, sometimes both muscles may be active at the same time (e.g., above a noise threshold). This may tend to happen during discrete or continuous events (e.g., such as those described earlier, when a user introduces an additional movement or gesture, whether transitory or sustained). By way of illustration, FIG. 20 shows a plot of example event paths through the feature space of FIG. 19 (i.e., the evolution of the neuromuscular data over time during an event). These event paths may be removed from the cluster of data points that represent the 1D signal. Accordingly, a single inferential model trained on the 1D signal may not handle events (such as the fist squeeze or thumb press described earlier) well. Thus, systems and methods described herein may determine the subregion within which a particular input falls to determine what inferential model to apply to the input.

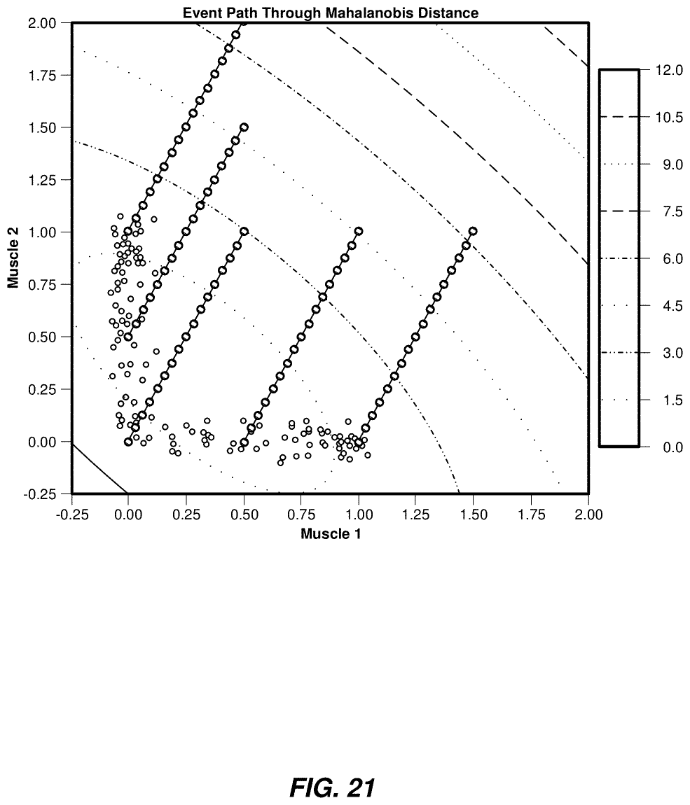

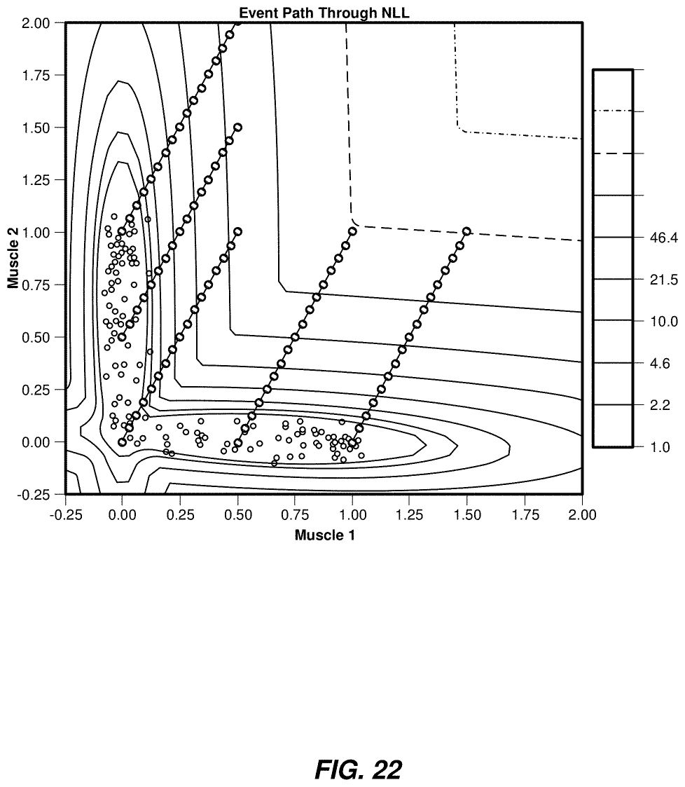

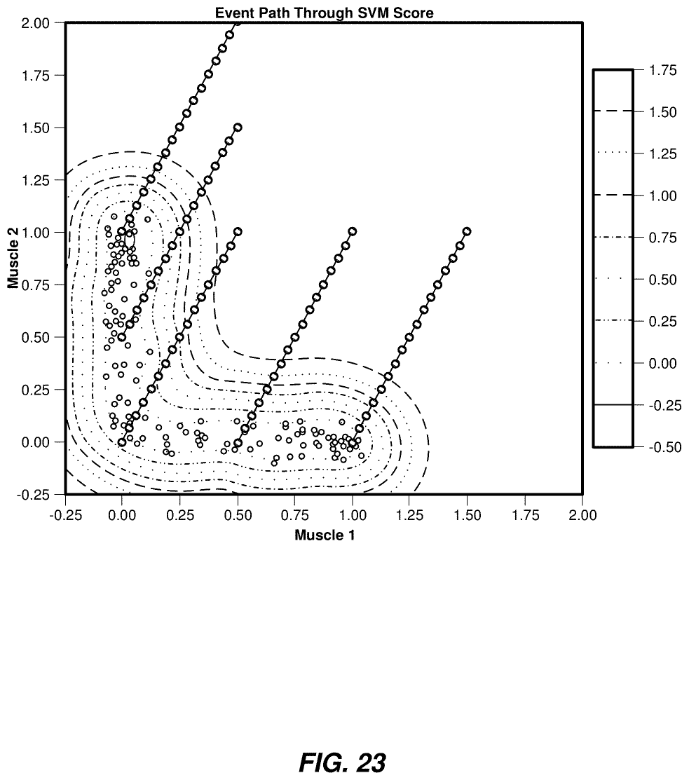

As discussed earlier, the systems described herein may use of a variety of metrics and methods to determine whether a particular input falls within a subregion. By way of illustration, FIG. 21 shows the event paths of FIG. 20 in comparison with the Mahalanobis distance from the cluster of inputs representing the original 1D signal. As may be appreciated from FIG. 21, while the Mahalanobis distance does differentiate the data points of the original 1D signal from the data points of the event paths to a degree (e.g., data points with a Mahalanobis distance of 3.0 or greater are all data points on the event paths), some ambiguity remains (e.g., at a Mahalanobis distance between 1.5 and 3.0, there are both some data points from the original 1D signal and some data points on the event paths). As an alternative, FIG. 22 shows the event paths of FIG. 20 in comparison with a distance metric based on a negative log likelihood (NLL) as determined by a Gaussian mixture model. As may be appreciated from FIG. 22, almost all data points from the original 1D signal fall within an NLL of 1.0 and the remainder fall within an NLL of 2.2, whereas most of the data points on the event paths fall outside of these bounds. Another alternative is illustrated in FIG. 23, which shows the event paths of FIG. 20 in comparison with a distance metric based on a support vector machine (SVM) score. Similar to the negative log likelihood of the Gaussian mixture model the SVM score successfully distinguishes many of the data points between the original 1D signal and the data points of the event paths.

Similar principles to those described above may be applied to feature spaces that describe two pairs of opposing muscles. If a user performs certain gestures (e.g., a “click” gesture), the user may activate all four muscles simultaneously, which may cause 2D output that previously assumed the activation of only one muscle in each pair at a time to become unpredictable (e.g., result in artifacts that deviate from the 2D output that would otherwise be expected). Accordingly, the systems described herein may detect when the artifacts occur and use a model trained to apply a correction function to the original 2D model. For example, if x represents the neuromuscular input, and the original 2D model is y=f₂d(x), a model trained to account for artifacts may be y=f_{2d}(x)+f_{correction}(x), where f_{correction}(x) is 0 when no event is occurring and is y₀−f_{2d}(x). Thus, the correction term in the model trained to account for artifacts may function as a detector for whether an input falls outside a default subregion of the feature space.

The correction function may be implemented in any suitable manner. In some examples, the systems described herein may use a radial basis function network to implement the correction function, which may have the advantage of being nonlinear, interpretable, and easy to train without requiring a large amount of data.

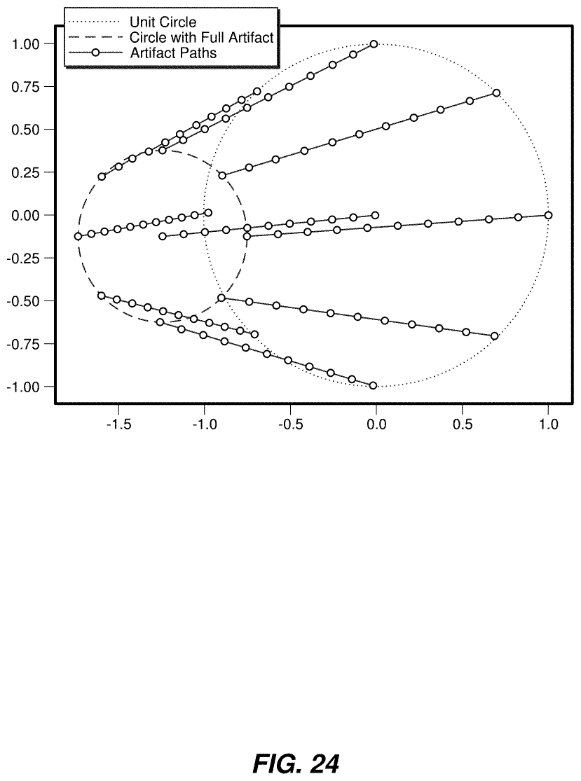

By way of illustration, FIG. 24 shows a plot of a 2D feature space (e.g., representing the possible activations of two pairs of muscles). A unit circle in FIG. 24 represents the set of expected data points. However, the circle with full artifacts represents the set of data points that may be observed during a particular event (e.g., the user making a “click” gesture). Artifact paths illustrate how inputs that would normally fall on the unit circle become projected onto the circle with full artifacts during an event. A correction function may therefore reverse such a projection, effectively mapping data points observed on the circle with full artifacts back onto the unit circle.

As mentioned earlier, in some examples a one Euro filter may be applied to filter noisy neuromuscular signals for high precision and responsiveness (e.g., before applying inferential models to the signals). In one example, a one Euro filter may be an exponential infinite impulse response filter with an adaptive time constant, as in Equation (10):

$$τ = \frac{{r}_{0}}{1 + α \overline{\vert \overline{V} x \vert}} \qquad ( 10 )$$

where |̅∇̅ x̅|̅ is a low passed filtered version of |∇ x|

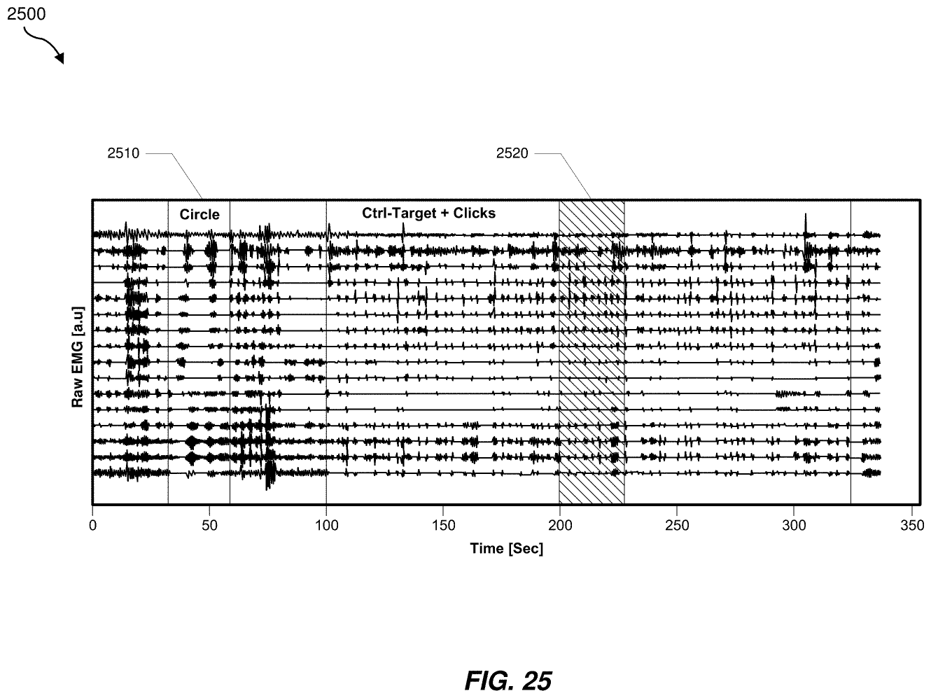

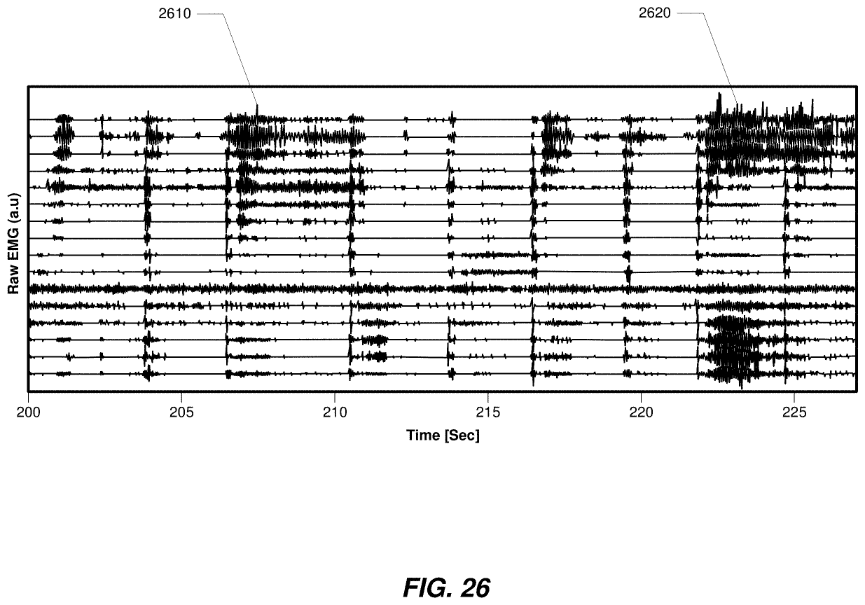

The one Euro filter may provide responsive output when activity varies a lot and stable output when activity is static (e.g., when tied to the movement of a cursor, the cursor may move responsively but remain stable when the user does not gesture for the cursor to move). However, the one Euro filter's timescale may be reduced when a large gradient is generated (e.g., when the user performs a clicking gesture), which may introduce instability in the cursor position. By way of illustration, FIG. 25 shows a plot 2500 of neuromuscular (e.g., EMG) data over time as a user performs various gestures. For example, at a time 2510 the user may be performing gestures to move a cursor around a circle. At a time 2520, the user may be performing clicking gestures while performing cursor movement gestures. FIG. 26 shows plot 2500 zoomed in to show the details of time 2510. As shown in FIG. 26, click gesture events, such as events 2610 and 2620, may introduce artifacts into the neuromuscular data, possibly causing inferential models to misinterpret the neuromuscular data as involving cursor movement.

Accordingly, the systems described herein may gate the responsiveness of the one Euro filter responsive to events. For example, the one Euro filter may be modified by introducing a click-related gating variable h≥0 and modifying the one Euro filter's adaptive time constant as shown in Equation (11):

$$τ = \frac{{τ}_{0}}{1 + σ ( h ) ( α \overline{\vert \overline{V} x \vert} )} \qquad ( 11 )$$

where σ(h) is sigmoid given by a function such as that shown in Equation (12) by way of example:

$$σ ( h ) = ( 1 - {g}_{min} ) \frac{1 + exp ( - β θ )}{1 + exp ( β ( h - θ ) )} + {g}_{min} \qquad ( 12 )$$

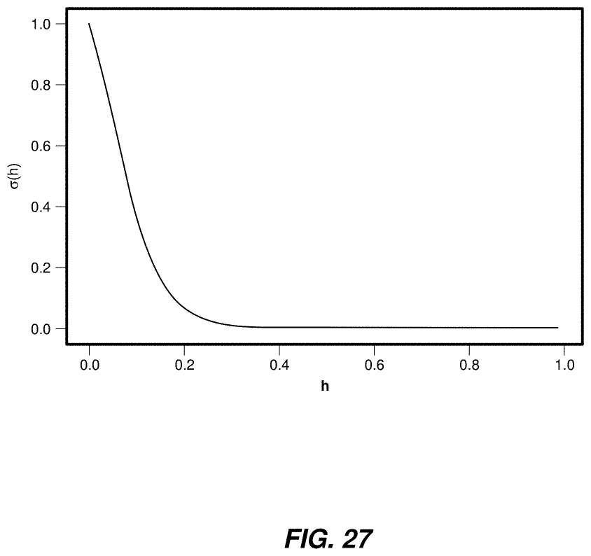

An illustration of a plot of an example σ(h) is also shown in FIG. 27. Thus, when h is larger than Θ the responsiveness of the filter is suppressed while when h is smaller than Θ the filter is equivalent to the one Euro filter. The gated filter may be referred to herein as a “two Euro filter.”

In some embodiments, the systems and methods disclosed herein may use a regularized linear model trained on one-Euro-filtered features. For example, given neuromuscular data features x(t) and desired output y(t), some embodiments may search for a set of weights w* that minimize the mean squared error for the data set as shown in Equation (13):

$${w}^{*} = arg {min}_{w} \frac{1}{2 T} {\sum }_{t} {( {y}_{t} - {w}^{T} {x}_{t} )}^{T} ( {y}_{t} - {w}^{T} {x}_{t} ) \qquad ( 13 )$$

The solution to Equation (13) can be analytically found and w* can be defined as w*=C⁻¹U.

In another embodiment, the systems described herein may use a ridge regression model. In this embodiment, a regularized version of linear regression where an additional term proportional to the L2-norm of the weights is added to the cost, as shown in Equation (14):

$${w}^{*} = arg {min}_{w} \frac{1 - ρ}{2 T} {\sum }_{t} {( {y}_{t} - {w}^{T} {x}_{t} )}^{T} ( {y}_{t} - {w}^{T} {x}_{t} ) + ρ {σ}^{2} {w}^{T} w \qquad ( 14 )$$

where σ² is the mean second moment of the inputs x(t). This leads to Equations (15):

w*=argmin_{w}½w^{T}[(1−ρ)C+ρσ²I]w−(1−ρ)w^{T}U

w*=(1−ρ)[(1−ρ)C+ρσ²I]⁻¹U (15)

Where the matrix of [(1−ρ)C+ρσ²I] is called the shrunk covariance of C.

In another step, systems described herein may perform a linear regression using the shrunk covariance estimator of C, instead of C itself. This may be expressed in the optimization cost function as shown in Equation (16):

w*=[(1−ρ)C+ρσ²I]⁻¹U (16)

Where this solution is proportional to the ridge regression solution as shown in Equation (17):

w_{ridge}*=(1−ρ)wₛₕᵣᵤₙₖ* (17)

Using the shrunk covariance solution may keep the output power high even when the regulatory parameter approaches 1.

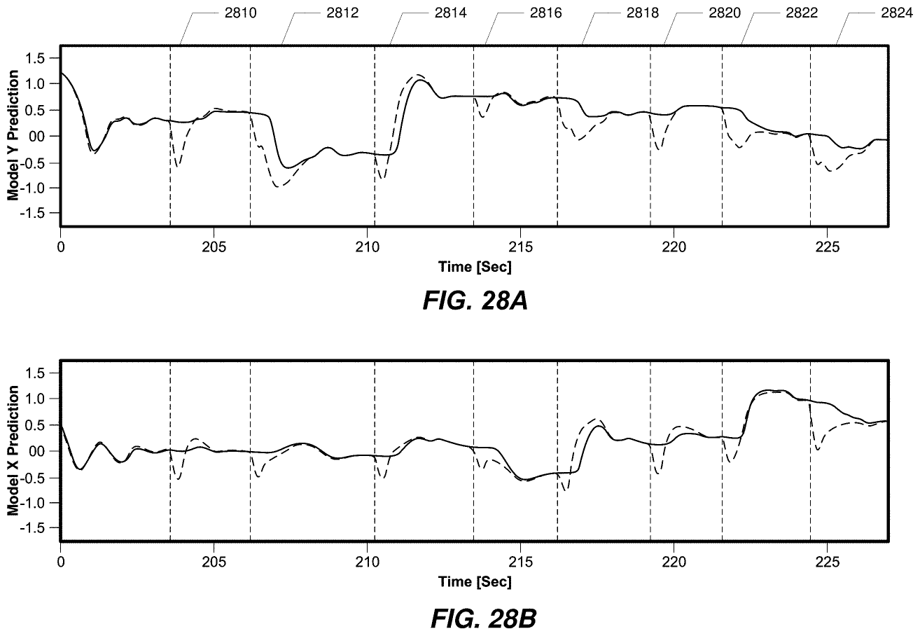

Using the shrunk covariance 2D model, the systems and methods disclosed herein may apply a two Euro filter to enhance performance. The application of the two Euro filter using the shrunk covariance 2D model may provide outputs that filter out otherwise disruptive events, such as click events. By way of illustration, FIGS. 28A and 28B show plots of model predictions using a one Euro filter (shown in the dashed line) and the two Euro filter described above (shown in the solid line). During events 2810, 2812, 2814, 2816, 2818, 2820, 2822, 2824 (e.g., the user clicking), the predicted position of a 2D cursor based on the user's movements experience disruptions when using the one Euro filter (possibly causing the cursor to appear to jump or jitter). However, the two Euro filter effectively filters out the artifacts caused by these events.

### EXAMPLE EMBODIMENTS

### Example 1

A computer-implemented method for control schemes using multiple distinct inferential models may include (1) receiving and processing a first plurality of signal data from one or more neuromuscular sensors, (2) creating a feature space defined by parameters corresponding to the first plurality of processed signal data, (3) mapping a plurality of regions within the feature space by (i) associating each of the plurality of regions with a corresponding input mode and (ii) associating each input mode with a corresponding inferential model, (4) automatically detecting an input mode based on the processed plurality of signal data. (5) automatically selecting a first inferential model based on the detected input mode, and (6) generating an output signal by applying the first inferential model to the processed plurality of signal data.

### Example 2

The computer-implemented method of Example 1, where wherein the input mode relates to classification of at least one of the following events: (1) hand poses, (2) discrete gestures, (3) continuous gestures, (4) finger taps, (5) 2-D wrist rotation, or (6) typing actions.

### Example 3

The computer-implemented method of Example 1, where the input mode relates to classification of a force level associated with at least one of the following events: (1) discrete gestures, (2) finger taps, (3) hand poses, or (4) continuous gestures.

### Example 4

The computer-implemented method of Example 1, where the selected first inferential model includes a personalized model previously trained based on processed signal data collected from the same user.

### Example 5

The computer-implemented method of Example 1, where identifying a plurality of regions within the feature space further comprises optimizing the size and shape of the regions based on a computational analysis of the processed signal data.

### Example 6

The computer-implemented method of Example 1, where processing the plurality of signal data comprises applying a one Euro filter to the plurality of signal data.

### Example 7

The computer-implemented method of Example 6, where automatically detecting the input mode based on the processed plurality of signal data comprises applying a gate that is associated with an input event that occurs within the input mode to the one Euro filter.

### Example 8

The computer-implemented method of Example 7, where applying the gate to the one Euro filter comprises modifying an adaptive time constant of the one Euro filter.

### Example 9

The computer-implemented method of Example 1, further including (1) processing the plurality of signal data to a lower-dimensional latent space, (2) presenting a visualization of the lower-dimensional latent space within a graphical interface, and (3) updating the visualization of the lower-dimensional latent space in real-time as new signal data is received by plotting the new signal data as one or more latent vectors within the lower-dimensional latent space.

### Example 10

The computer-implemented method of Example 9, where the visualization of the latent space includes a visualization of boundaries between latent classification subregions within the latent space.

### Example 11

The computer-implemented method of Example 10, where: (1) one or more of the latent classification subregions correspond to the plurality of regions and (2) the visualization of the latent space comprises labels applied to the latent classification subregions that describe corresponding input modes of the latent classification subregions.

### Example 12

The computer-implemented method of Example 9, further including: (1) presenting a repeated prompt within the graphical interface for a user to perform a target input, (2) identifying the new signal data as an attempt by the user to perform the target input, (3) determining that the new signal data falls in inconsistent latent classification subregions, and (4) presenting a prompt to the user to retrain the first inferential model.

### Example 13

The computer-implemented method of Example 9, further including: (1) presenting a repeated prompt within the graphical interface for a user to perform a target input, (2) identifying the new signal data as an attempt by the user to perform the target input, (3) determining that the new signal data falls in inconsistent latent classification subregions, and (4) receiving input from the user to modify the first inferential model such that the new signal data would fall within the latent classification subregion corresponding to the target input.

### Example 14

A system including: (1) one or more neuromuscular sensors that receive a plurality of signal data from a user, and (2) at least one physical processor and a physical memory comprising computer-executable instructions that, when executed by the physical processor, cause the physical processor to: (i) receive and process the plurality of signal data, (ii) map the processed signal data to a feature space defined by parameters corresponding to the processed signal data, (iii) identify a first subregion within the feature space based on a first plurality of processed signal data, (iv) identify a second subregion within the feature space based on a second plurality of processed signal data, (v) apply a first inferential model to a third plurality of processed signal data based on the third plurality of processed signal data corresponding to the first subregion of the feature space, and (vi) apply a second inferential model to a fourth plurality of processed signal data based on the fourth plurality of processed signal data corresponding to the second subregion of the feature space.

A wearable device equipped with an array of neuromuscular sensors implemented to control and interact with computer-based systems and to enable users to engage with interactive media in unrestrictive ways is disclosed herein. The wearable system (“armband system”) can be worn on the arm or wrist and used to control other devices (e.g., robots, Internet of things (IoT) devices and other suitable computing devices) and elements of interactive media based on neuromuscular signals that correlate to hand and arm movements, poses, gestures, and forces (isometric or other) recognized by the armband system. Some interactive tasks enabled by the armband system include selecting and activating graphical objects displayed on a two-dimensional space, moving graphical objects in a two-dimensional space, hovering over graphical objects, and other suitable interactions. Such interactions are based on hand and arm movements, poses, gestures, and forces recognized by the armband system.

The armband system recognizes arm and hand movements, poses, gestures, and forces via a user-specific inference model and maps such actions into a two-dimensional space, e.g., a computer screen, smart TV or other suitable device. The inference model can include one or more statistical models, one or more machine learning models, and/or a combination of one or more statistical model and/or one or more machine learning model. The inference model is user specific, because it is trained with data recorded from the user's neuromuscular activity and related movements and forces generated. The user neuromuscular signals are collected via the armband system. Thereafter, the inference model is trained with the collected user data to build a user-specific inference model. The user-specific inference model is adapted to the user and can handle user-specific characteristics or particularities associated with movements, poses, forces, and/or gestures performed by individual users. Accordingly, after training, the armband system is adapted into a personalized human computer interface.

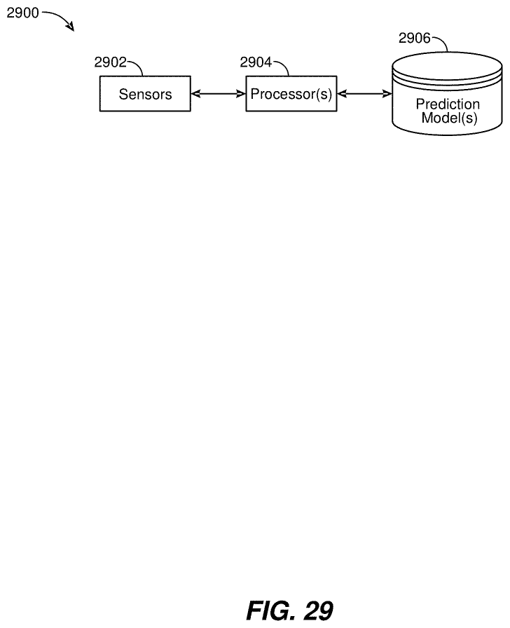

FIG. 29 illustrates a system 2900 in accordance with some embodiments. The system includes a plurality of sensors 2902 configured to record signals arising from neuromuscular activity in skeletal muscle of a human body. The term “neuromuscular activity” as used herein refers to neural activation of spinal motor neurons that innervate a muscle, muscle activation, muscle contraction, or any combination of the neural activation, muscle activation, and muscle contraction. Neuromuscular sensors may include one or more electromyography (EMG) sensors, one or more mechanomyography (MMG) sensors, one or more sonomyography (SMG) sensors, one or more electrical impedance tomography (EIT) sensors, a combination of two or more types of EMG sensors, MMG sensors, SMG, and EIT sensors, and/or one or more sensors of any suitable type that configured to detect signals derived from neuromuscular activity. In some embodiments, the plurality of neuromuscular sensors may be used to sense signals derived from muscular activity related to a movement of the part of the body controlled by muscles from which the neuromuscular sensors are arranged to sense the muscle activity. Spatial information (e.g., position and/or orientation information) and force information describing the movement may be predicted based on the sensed neuromuscular signals as the user moves over time or performs one or more gestures.

Sensors 2902 may include one or more Inertial Measurement Units (IMUs), which measure a combination of physical aspects of motion, using, for example, an accelerometer, a gyroscope, a magnetometer, or any combination of one or more accelerometers, gyroscopes and magnetometers. In some embodiments, IMUs may be used to sense information about the movement of the part of the body on which the IMU is attached and information derived from the sensed data (e.g., position and/or orientation information) may be tracked as the user moves over time. For example, one or more IMUs may be used to track movements of portions of a user's body proximal to the user's torso relative to the sensor (e.g., arms, legs) as the user moves over time or performs one or more gestures.

In embodiments that include at least one IMU and a plurality of neuromuscular sensors, the IMU(s) and neuromuscular sensors may be arranged to detect movement of different parts of the human body. For example, the IMU(s) may be arranged to detect movements of one or more body segments proximal to the torso (e.g., an upper arm), whereas the neuromuscular sensors may be arranged to detect movements of one or more body segments distal to the torso (e.g., a forearm or wrist). It should be appreciated, however, that sensors may be arranged in any suitable way, and embodiments of the technology described herein are not limited based on the particular sensor arrangement. For example, in some embodiments, at least one IMU and a plurality of neuromuscular sensors may be co-located on a body segment to track movements of body segment using different types of measurements. In one implementation described in more detail below, an IMU sensor and a plurality of EMG sensors are arranged on an armband system configured to be worn around the lower arm or wrist of a user. In such an arrangement, the IMU sensor may be configured to track movement information (e.g., positioning and/or orientation over time) associated with one or more arm segments, to determine, for example whether the user has raised or lowered their arm, whereas the EMG sensors may be configured to determine movement information associated with wrist or hand segments to determine, for example, whether the user is holding an open or closed hand.

Each of the sensors 2902 includes one or more sensing components configured to sense information about a user. In the case of one or more IMU sensors, the sensing components may include one or more accelerometers, gyroscopes, magnetometers, or any combination thereof to measure characteristics of body motion, examples of which include, but are not limited to, acceleration, angular velocity, and sensed magnetic field around the body. In the case of neuromuscular sensors, the sensing components may include, but are not limited to, electrodes configured to detect electric potentials on the surface of the body (e.g., for EMG sensors) vibration sensors configured to measure skin surface vibrations (e.g., for MMG sensors), acoustic sensing components configured to measure ultrasound signals (e.g., for SMG sensors) arising from muscle activity, and electrical sensing components to measure electrical impedance (e.g., for EIT sensors) from skin.

In some embodiments, at least some of the plurality of sensors 2902 are arranged as a portion of an armband device configured to be worn on or around part of a user's body. For example, in one non-limiting example, an IMU sensor and a plurality of neuromuscular sensors can be arranged circumferentially around an adjustable and/or elastic band such as a wristband or armband configured to be worn around a user's wrist or arm. In some embodiments, multiple armband devices, each having one or more IMUs and/or neuromuscular sensors included thereon may be used to predict musculoskeletal position information for movements, poses, or gestures that involve multiple parts of the body.

In some embodiments, sensors 2902 only include a plurality of neuromuscular sensors (e.g., EMG sensors). In other embodiments, sensors 2902 include a plurality of neuromuscular sensors and at least one “auxiliary” sensor configured to continuously record a plurality of auxiliary signals. Examples of auxiliary sensors include, but are not limited to, other sensors such as IMU sensors, and external sensors such as an imaging device (e.g., a camera), a radiation-based sensor for use with a radiation-generation device (e.g., a laser-scanning device), or other types of sensors such as a heart-rate monitor.

In some embodiments, the output of one or more of the sensing components may be processed using hardware signal processing circuitry (e.g., to perform amplification, filtering, and/or rectification). In other embodiments, at least some signal processing of the output of the sensing components may be performed in software. Thus, signal processing of signals recorded by the sensors may be performed in hardware, software, or by any suitable combination of hardware and software, as aspects of the technology described herein are not limited in this respect.

In some embodiments, the recorded sensor data may be processed to compute additional derived measurements or features that are then provided as input to an inference model, as described in more detail below. For example, recorded sensor data can be used to generate ground truth information to build a user-specific inference model. For another example, recorded signals from an IMU sensor may be processed to derive an orientation signal that specifies the orientation of a rigid body segment over time. Sensors 2902 may implement signal processing using components integrated with the sensing components, or at least a portion of the signal processing may be performed by one or more components in communication with, but not directly integrated with the sensing components of the sensors.

System 2900 also includes one or more computer processors 2904 programmed to communicate with sensors 2902. For example, signals recorded by one or more of the sensors may be provided to the processor(s), which may be programmed to process signals output by the sensors 2902 to train one or more inference models 2906, the trained (or retrained) inference model(s) 2906 may be stored for later use in identifying/classifying gestures and generating control/command signals, as described in more detail below. In some embodiments, the processors 2904 may be programmed to derive one or more features associated with one or more gestures performed by a user and the derived feature(s) may be used to train the one or more inference models 2906. The processors 2904 may be programmed to identify a subsequently performed gesture based on the trained one or more inference models 2906. In some implementations, the processors 2904 may be programmed to utilize the inference model, at least in part, to map an identified gesture to one or more control/command signals.

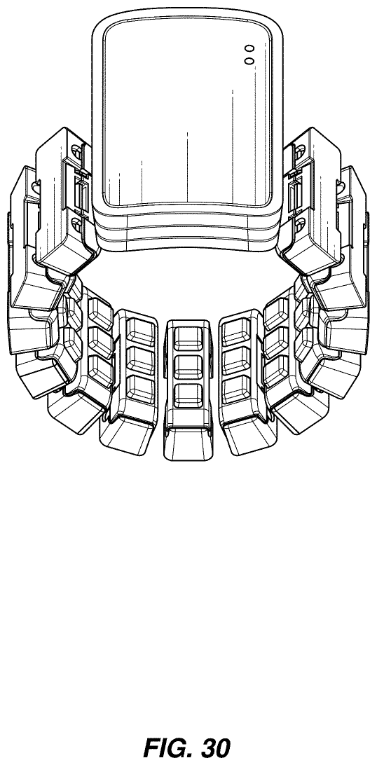

FIG. 30 illustrates an armband system with an array of neuromuscular sensors (e.g., EMG sensors) arranged circumferentially around an elastic band configured to be worn around a user's lower arm or wrist. As shown, differential neuromuscular sensors are arranged circumferentially and coupled with one or more elastic bands. It should be appreciated that any suitable number of neuromuscular sensors may be used. The number and arrangement of neuromuscular sensors may depend on the particular application for which the armband system is used. For example, a wearable armband or wristband can be used to generate control information for controlling an augmented reality system, a virtual reality system, a robot, controlling a vehicle, scrolling through text, controlling a virtual avatar, or any other suitable control task. As shown the sensors may be coupled together using flexible electronics incorporated into the armband device.

In some embodiments, the output of one or more of the sensors can be optionally processed using hardware signal processing circuitry (e.g., to perform amplification, filtering, and/or rectification). In other embodiments, at least some signal processing of the output of the sensors can be performed in software. Thus, processing of signals sampled by the sensors can be performed in hardware, software, or by any suitable combination of hardware and software, as aspects of the technology described herein are not limited in this respect.

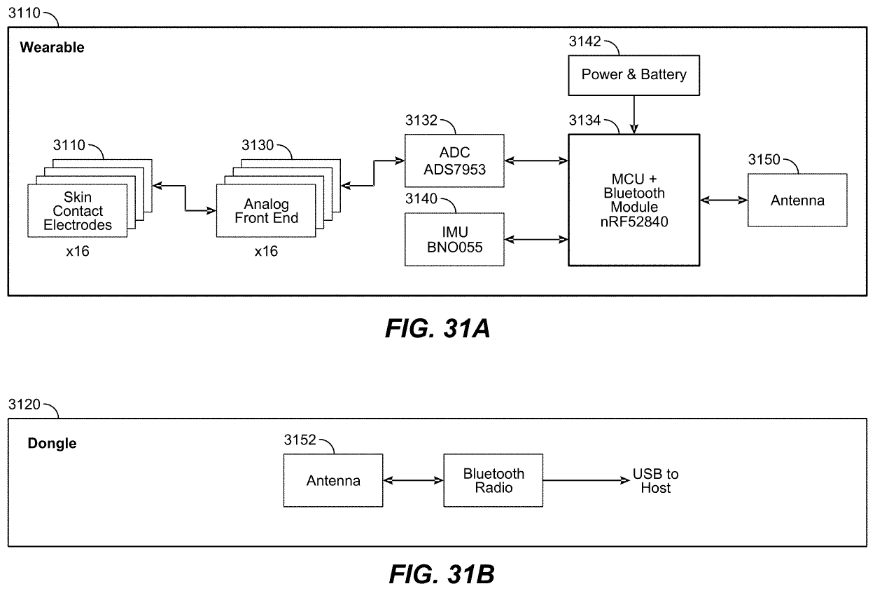

FIGS. 31A and 31B below illustrate a schematic diagram with internal components of a wearable system with sixteen EMG sensors, in accordance with some embodiments of the technology described herein. As shown, the wearable system includes a wearable portion 3110 (FIG. 31A) and a dongle portion 3120 (FIG. 31B) in communication with the wearable portion 3110 (e.g., via Bluetooth or another suitable short-range wireless communication technology). As shown in FIG. 11A, the wearable portion 3110 includes the sensors 2902, examples of which are described in connection with FIG. 29. The output of the sensors 2902 is provided to analog front end 3130 configured to perform analog processing (e.g., noise reduction, filtering, etc.) on the recorded signals. The processed analog signals are then provided to analog-to-digital converter 3132, which converts the analog signals to digital signals that can be processed by one or more computer processors. An example of a computer processor that may be used in accordance with some embodiments is microcontroller (MCU) 3134 illustrated in FIG. 31A. As shown, MCU 3134 may also include inputs from other sensors (e.g., IMU sensor 3140), and power and battery module 3142. The output of the processing performed by MCU may be provided to antenna 3150 for transmission to dongle portion 3120 shown in FIG. 31B.

Dongle portion 3120 includes antenna 3152 configured to communicate with antenna 3150 included as part of wearable portion 3110. Communication between antenna 3150 and 3152 may occur using any suitable wireless technology and protocol, non-limiting examples of which include radiofrequency signaling and Bluetooth. As shown, the signals received by antenna 3152 of dongle portion 3120 may be provided to a host computer for further processing, display, and/or for effecting control of a particular physical or virtual object or objects.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

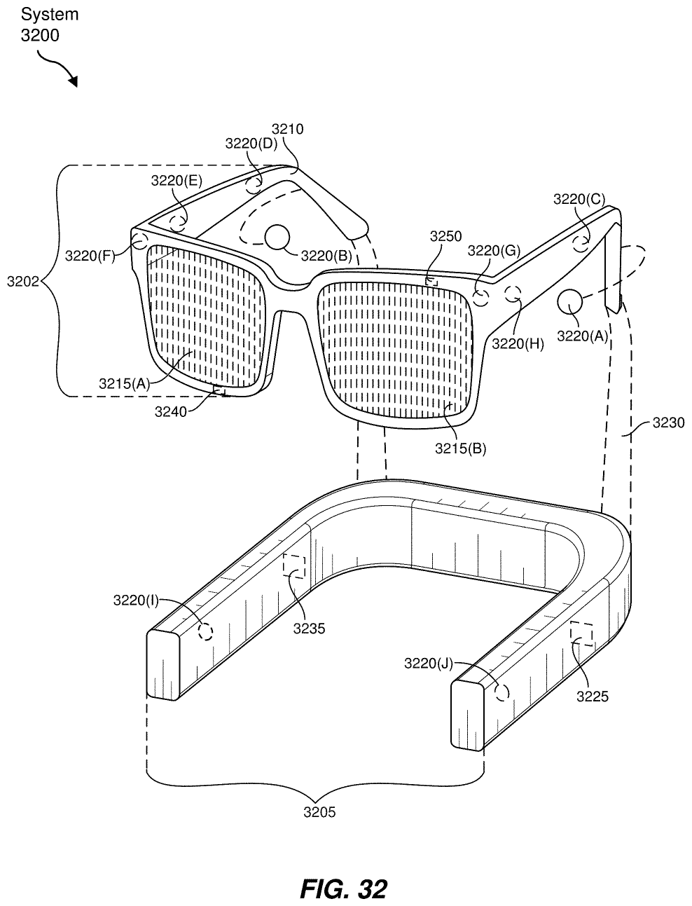

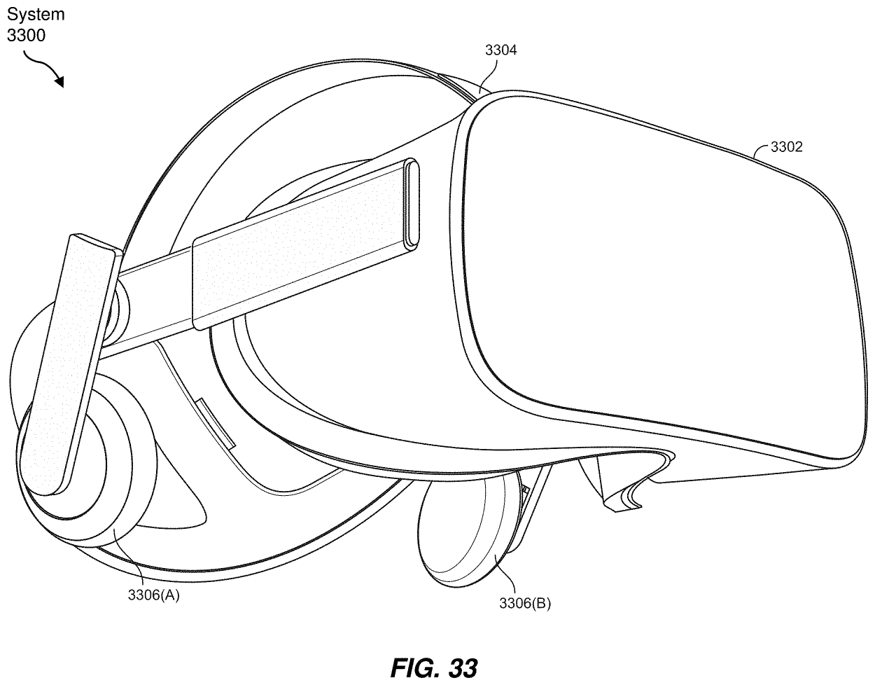

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 3200 in FIG. 32) or that visually immerses a user in an artificial reality (such as, e.g., virtual-reality system 3300 in FIG. 33). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 32, augmented-reality system 3200 may include an eyewear device 3202 with a frame 3210 configured to hold a left display device 3215(A) and a right display device 3215(B) in front of a user's eyes. Display devices 3215(A) and 3215(B) may act together or independently to present an image or series of images to a user. While augmented-reality system 3200 includes two displays, embodiments of this disclosure may be implemented in augmented-reality systems with a single NED or more than two NEDs.

In some embodiments, augmented-reality system 3200 may include one or more sensors, such as sensor 3240. Sensor 3240 may generate measurement signals in response to motion of augmented-reality system 3200 and may be located on substantially any portion of frame 3210. Sensor 3240 may represent one or more of a variety of different sensing mechanisms, such as a position sensor, an inertial measurement unit (IMU), a depth camera assembly, a structured light emitter and/or detector, or any combination thereof. In some embodiments, augmented-reality system 3200 may or may not include sensor 3240 or may include more than one sensor. In embodiments in which sensor 3240 includes an IMU, the IMU may generate calibration data based on measurement signals from sensor 3240. Examples of sensor 3240 may include, without limitation, accelerometers, gyroscopes, magnetometers, other suitable types of sensors that detect motion, sensors used for error correction of the IMU, or some combination thereof.

In some examples, augmented-reality system 3200 may also include a microphone array with a plurality of acoustic transducers 3220(A)-3220(J), referred to collectively as acoustic transducers 3220. Acoustic transducers 3220 may represent transducers that detect air pressure variations induced by sound waves. Each acoustic transducer 3220 may be configured to detect sound and convert the detected sound into an electronic format (e.g., an analog or digital format). The microphone array in FIG. 33 may include, for example, ten acoustic transducers: 3220(A) and 3220(B), which may be designed to be placed inside a corresponding ear of the user, acoustic transducers 3220(C), 3220(D), 3220(E), 3220(F), 3220(G), and 3220(H), which may be positioned at various locations on frame 3210, and/or acoustic transducers 3220(I) and 3220(J), which may be positioned on a corresponding neckband 3205.

In some embodiments, one or more of acoustic transducers 3220(A)-(F) may be used as output transducers (e.g., speakers). For example, acoustic transducers 3220(A) and/or 3220(B) may be earbuds or any other suitable type of headphone or speaker.

The configuration of acoustic transducers 3220 of the microphone array may vary. While augmented-reality system 3200 is shown in FIG. 32 as having ten acoustic transducers 3220, the number of acoustic transducers 3220 may be greater or less than ten. In some embodiments, using higher numbers of acoustic transducers 3220 may increase the amount of audio information collected and/or the sensitivity and accuracy of the audio information. In contrast, using a lower number of acoustic transducers 3220 may decrease the computing power required by an associated controller 3250 to process the collected audio information. In addition, the position of each acoustic transducer 3220 of the microphone array may vary. For example, the position of an acoustic transducer 3220 may include a defined position on the user, a defined coordinate on frame 3210, an orientation associated with each acoustic transducer 3220, or some combination thereof.

Acoustic transducers 3220(A) and 3220(B) may be positioned on different parts of the user's ear, such as behind the pinna, behind the tragus, and/or within the auricle or fossa. Or, there may be additional acoustic transducers 3220 on or surrounding the ear in addition to acoustic transducers 3220 inside the ear canal. Having an acoustic transducer 3220 positioned next to an ear canal of a user may enable the microphone array to collect information on how sounds arrive at the ear canal. By positioning at least two of acoustic transducers 3220 on either side of a user's head (e.g., as binaural microphones), augmented-reality device 3200 may simulate binaural hearing and capture a 3D stereo sound field around about a user's head. In some embodiments, acoustic transducers 3220(A) and 3220(B) may be connected to augmented-reality system 3200 via a wired connection 3230, and in other embodiments acoustic transducers 3220(A) and 3220(B) may be connected to augmented-reality system 3200 via a wireless connection (e.g., a Bluetooth connection). In still other embodiments, acoustic transducers 3220(A) and 3220(B) may not be used at all in conjunction with augmented-reality system 3200.

Acoustic transducers 3220 on frame 3210 may be positioned in a variety of different ways, including along the length of the temples, across the bridge, above or below display devices 3215(A) and 3215(B), or some combination thereof. Acoustic transducers 3220 may also be oriented such that the microphone array is able to detect sounds in a wide range of directions surrounding the user wearing the augmented-reality system 3200. In some embodiments, an optimization process may be performed during manufacturing of augmented-reality system 3200 to determine relative positioning of each acoustic transducer 3220 in the microphone array.

In some examples, augmented-reality system 3200 may include or be connected to an external device (e.g., a paired device), such as neckband 3205. Neckband 3205 generally represents any type or form of paired device. Thus, the following discussion of neckband 3205 may also apply to various other paired devices, such as charging cases, smart watches, smart phones, wrist bands, other wearable devices, hand-held controllers, tablet computers, laptop computers, other external compute devices, etc.

As shown, neckband 3205 may be coupled to eyewear device 3202 via one or more connectors. The connectors may be wired or wireless and may include electrical and/or non-electrical (e.g., structural) components. In some cases, eyewear device 3202 and neckband 3205 may operate independently without any wired or wireless connection between them. While FIG. 32 illustrates the components of eyewear device 3202 and neckband 3205 in example locations on eyewear device 3202 and neckband 3205, the components may be located elsewhere and/or distributed differently on eyewear device 3202 and/or neckband 3205. In some embodiments, the components of eyewear device 3202 and neckband 3205 may be located on one or more additional peripheral devices paired with eyewear device 3202, neckband 3205, or some combination thereof.

Pairing external devices, such as neckband 3205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 3200 may be provided by a paired device or shared between a paired device and an eyewear device, thus reducing the weight, heat profile, and form factor of the eyewear device overall while still retaining desired functionality. For example, neckband 3205 may allow components that would otherwise be included on an eyewear device to be included in neckband 3205 since users may tolerate a heavier weight load on their shoulders than they would tolerate on their heads. Neckband 3205 may also have a larger surface area over which to diffuse and disperse heat to the ambient environment. Thus, neckband 3205 may allow for greater battery and computation capacity than might otherwise have been possible on a stand-alone eyewear device. Since weight carried in neckband 3205 may be less invasive to a user than weight carried in eyewear device 3202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 3205 may be communicatively coupled with eyewear device 3202 and/or to other devices. These other devices may provide certain functions (e.g., tracking, localizing, depth mapping, processing, storage, etc.) to augmented-reality system 3200. In the embodiment of FIG. 32, neckband 3205 may include two acoustic transducers (e.g., 3220(I) and 3220(J)) that are part of the microphone array (or potentially form their own microphone subarray). Neckband 3205 may also include a controller 3225 and a power source 3235.

Acoustic transducers 3220(I) and 3220(J) of neckband 3205 may be configured to detect sound and convert the detected sound into an electronic format (analog or digital). In the embodiment of FIG. 32, acoustic transducers 3220(I) and 3220(J) may be positioned on neckband 3205, thereby increasing the distance between the neckband acoustic transducers 3220(I) and 3220(J) and other acoustic transducers 3220 positioned on eyewear device 3202. In some cases, increasing the distance between acoustic transducers 3220 of the microphone array may improve the accuracy of beamforming performed via the microphone array. For example, if a sound is detected by acoustic transducers 3220(C) and 3220(D) and the distance between acoustic transducers 3220(C) and 3220(D) is greater than, e.g., the distance between acoustic transducers 3220(D) and 3220(E), the determined source location of the detected sound may be more accurate than if the sound had been detected by acoustic transducers 3220(D) and 3220(E).

Controller 3225 of neckband 3205 may process information generated by the sensors on neckband 3205 and/or augmented-reality system 3200. For example, controller 3225 may process information from the microphone array that describes sounds detected by the microphone array. For each detected sound, controller 3225 may perform a direction-of-arrival (DOA) estimation to estimate a direction from which the detected sound arrived at the microphone array. As the microphone array detects sounds, controller 3225 may populate an audio data set with the information. In embodiments in which augmented-reality system 3200 includes an inertial measurement unit, controller 3225 may compute all inertial and spatial calculations from the IMU located on eyewear device 3202. A connector may convey information between augmented-reality system 3200 and neckband 3205 and between augmented-reality system 3200 and controller 3225. The information may be in the form of optical data, electrical data, wireless data, or any other transmittable data form. Moving the processing of information generated by augmented-reality system 3200 to neckband 3205 may reduce weight and heat in eyewear device 3202, making it more comfortable to the user.

Power source 3235 in neckband 3205 may provide power to eyewear device 3202 and/or to neckband 3205. Power source 3235 may include, without limitation, lithium ion batteries, lithium-polymer batteries, primary lithium batteries, alkaline batteries, or any other form of power storage. In some cases, power source 3235 may be a wired power source. Including power source 3235 on neckband 3205 instead of on eyewear device 3202 may help better distribute the weight and heat generated by power source 3235.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 3300 in FIG. 33, that mostly or completely covers a user's field of view. Virtual-reality system 3300 may include a front rigid body 3302 and a band 3304 shaped to fit around a user's head. Virtual-reality system 3300 may also include output audio transducers 3306(A) and 3306(B). Furthermore, while not shown in FIG. 33, front rigid body 3302 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 3200 and/or virtual-reality system 3300 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some the artificial-reality systems described herein may include one or more projection systems. For example, display devices in augmented-reality system 3200 and/or virtual-reality system 3300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 3200 and/or virtual-reality system 3300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
one or more neuromuscular sensors that receive a plurality of signal data from a user;
at least one physical processor;
physical memory comprising computer-executable instructions that, when executed by the physical processor, cause the physical processor to:
receive and process the plurality of signal data;
map the processed signal data to a feature space defined by one or more parameters corresponding to the processed signal data;
identify a first subregion within the feature space based on the mapping of a first plurality of processed signal data;
associate a first inferential model with the identified first subregion within the feature space; and
apply the first inferential model to a third plurality of processed signal data based on the mapping of a third plurality of processed signal data corresponding to the first subregion of the feature space.

2. The system of claim 1, wherein the computer-executable instructions further cause the physical processor to:
identify a second subregion within the feature space based on a second plurality of processed signal data; and
apply a second inferential model to a fourth plurality of processed signal data based on the fourth plurality of processed signal data corresponding to the second subregion of the feature space.

3. A system comprising:
one or more neuromuscular sensors that receive a plurality of signal data from a user;
at least one physical processor;
physical memory comprising computer-executable instructions that, when executed by the physical processor, cause the physical processor to:
receive and process a first plurality of signal data;
generate a feature space defined by one or more parameters corresponding to the first plurality of processed signal data;
map a plurality of regions within the feature space, wherein mapping the plurality of regions comprises:
associating each of the plurality of regions with a corresponding input mode; and
associating each input mode with a corresponding inferential model;
automatically detect an input mode based on a second plurality of signal data;
automatically select a first inferential model based on the detected input mode; and
generate an output signal by applying the first inferential model to the second plurality of signal data.

4. The system of claim 3, wherein the input mode relates to classification of at least one of the following events:
hand poses;
discrete gestures;
continuous gestures;
finger taps;
2-D wrist rotation; or
typing actions.

5. The system of claim 3, wherein the input mode relates to classification of a force level associated with at least one of the following events:
discrete gestures;
finger taps;
hand poses; or
continuous gestures.

6. The system of claim 3, wherein the selected first inferential model comprises a personalized model previously trained based on processed signal data collected from the same user.

7. The system of claim 3, wherein identifying a plurality of regions within the feature space further comprises optimizing the size and shape of the regions based on a computational analysis of the processed signal data.

8. The system of claim 3, wherein processing the plurality of signal data comprises applying either a one Euro filter or a two Euro filter to the plurality of signal data.

9. The system of claim 8, wherein automatically detecting the input mode based on the processed plurality of signal data comprises applying a gate that is associated with an input event that occurs within the input mode to the one Euro filter.

10. The system of claim 9, wherein applying the gate to the one Euro filter comprises modifying an adaptive time constant of the one Euro filter.

11. The system of claim 3, wherein the computer-executable instructions further cause the physical processor to:
process the plurality of signal data to generate a lower-dimensional latent space;
present a visualization of the lower-dimensional latent space within a graphical interface; and
update the visualization of the lower-dimensional latent space in real-time as new signal data is received by plotting the new signal data as one or more latent vectors within the lower-dimensional latent space.

12. The system of claim 11, wherein the visualization of the latent space comprises a visualization of boundaries between latent classification subregions within the latent space.

13. The system of claim 12, wherein:
one or more of the latent classification subregions correspond to the plurality of regions; and
the visualization of the latent space comprises labels applied to the latent classification subregions that describe corresponding input modes of the latent classification subregions.

14. The system of claim 11, wherein the computer-executable instructions further cause the physical processor to:
present a repeated prompt within the graphical interface for a user to perform a target input;
identify the new signal data as an attempt by the user to perform the target input;
determine that the new signal data falls in inconsistent latent classification subregions; and
presenting a prompt to the user to retrain the first inferential model.

15. The system of claim 11, wherein the computer-executable instructions further cause the physical processor to:
present a repeated prompt within the graphical interface for a user to perform a target input;
identify the new signal data as an attempt by the user to perform the target input;
determine that the new signal data does not fall within a latent classification subregion corresponding to the target input; and
receive input from the user to modify the first inferential model such that the new signal data would fall within the latent classification subregion corresponding to the target input.

16. A computer-implemented method comprising:
receiving and processing an initial plurality of signal data from one or more neuromuscular sensors;
generating a feature space defined by one or more parameters corresponding to the initial plurality of processed signal data;
mapping a plurality of regions within the feature space, wherein mapping the plurality of regions comprises:
associating each of the plurality of regions with a corresponding input mode; and
associating each input mode with a corresponding inferential model;
automatically detecting an input mode based on a subsequent plurality of signal data;
automatically selecting the corresponding inferential model based on the detected input mode; and
generating an output signal by applying the corresponding inferential model to the subsequent plurality of signal data.

17. The computer-implemented method of claim 16, wherein the input mode relates to classification of at least one of the following events:
hand poses;
discrete gestures;
continuous gestures;
finger taps;
2-D wrist rotation; or
typing actions.

18. The computer-implemented method of claim 16, wherein processing the plurality of signal data comprises applying a one Euro filter or a two Euro filter to the plurality of signal data.

19. The computer-implemented method of claim 18, wherein automatically detecting the input mode based on the subsequent plurality of signal data comprises applying a gate that is associated with an input event that occurs within the input mode to the one Euro filter.

20. The computer-implemented method of claim 16, further comprising:
processing the plurality of signal data to a lower-dimensional latent space;
presenting a visualization of the lower-dimensional latent space within a graphical interface; and
updating the visualization of the lower-dimensional latent space in real-time as new signal data is received by plotting the new signal data as one or more latent vectors within the lower-dimensional latent space.
